(19) United States
(12) Patent Application Publication
(10) Pub. No.: US 2025/0013691 A1
(43) Pub. Date: Jan. 9, 2025

(54) VIDEO RECOMMENDATION METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Chuanlong ZU, Shenzhen (CN)

(21) Appl. No.: 18/895,549

(22) Filed: Sep. 25, 2024

Related U.S. Application Data
(63) Continuation of application No. PCT/CN2023/088886, filed on Apr. 18, 2023.

(30) Foreign Application Priority Data
Nov. 30, 2022 (CN) 202211526679.9

(51) Int. Cl. G06F 16/735; G06F 16/783; G06V 10/77; G06V 10/774; G06V 10/776; G06V 10/82; G06V 20/40

(52) U.S. Cl. CPC G06F 16/735; G06F 16/7837; G06V 10/7715; G06V 10/774; G06V 10/776; G06V 10/82; G06V 20/46; G06V 20/48

(57) ABSTRACT

A video recommendation method includes: obtaining an object feature vector of a target object, a historical playback sequence of the target object in a preset historical time period, and a video multi-target vector index of each video in a video library; and performing vectorization processing on the historical playback sequence to obtain an object enhanced vector of the target object; sequentially performing vector concatenation processing and multi-target feature learning on the object feature vector and the object enhanced vector to obtain an object multi-target vector of the target object; and determining, from the video library based on the object multi-target vector and the video multi-target vector index of each video, a target recommended video corresponding to the target object.

### CROSS-REFERENCES TO RELATED APPLICATIONS

This application is a continuation application of PCT Patent Application No. PCT/CN2023/088886, filed on Apr. 18, 2023, which is proposed based on and claims priority to Chinese Patent Application No. 202211526679.9 filed on Nov. 30, 2022, all of which is incorporated by reference in their entirety.

### FIELD OF THE TECHNOLOGY

Embodiments of the present disclosure relate to the field of Internet and, in particular, relate to a video recommendation method and apparatus, an electronic device, a computer-readable storage medium, and a computer program product.

### BACKGROUND OF THE DISCLOSURE

A commonly used video recall structure in the field of video recommendation often includes a dual-tower structure and a double-enhanced dual-tower structure.

As a typical recall structure, the dual-tower structure has been widely used in recommendation scenarios due to convenient offline training and fast online retrieval. The most typical feature of the dual-tower structure is that “the dual towers are independent”. Target vectors of massive content can be calculated offline in batches, and there is no need to repeat the calculation online. User target vectors need to be calculated only once online, then fast retrieval of similar content can be implemented using a nearest neighbor algorithm. However, the “independent dual towers” also limit model effects. The dual-tower structure lacks an opportunity to cross-learn user features and content features, while cross-features and cross-learning may significantly improve the model effect. The double-enhanced dual-tower structure generates, at an input layer of a user tower or an input layer of a content tower, vectors for fitting information of the other tower. The vector is referred to as an “enhanced vector”, and the enhanced vector is continuously updated by using a target vector of the other tower and is involved in a process of calculating the target vector. However, a parameter scale of the enhanced vector of the user tower in the double-enhanced dual-tower structure is excessively large, and the tower structure does not support multiple targets, and therefore multiple target vectors cannot be fitted at the same time using the enhanced vector.

The calculation amount is thus large due to an excessively large parameter scale during recall calculation using the video recall structure, resulting in a high calculation delay of a recall process during video recommendation and a reduction in efficiency of video recommendation. In addition, target vectors in multiple dimensions cannot be fit at the same time, providing low accuracy of the recall calculation.

### SUMMARY

One embodiment of the present disclosure provides a video recommendation method, performed by an electronic device. The method includes obtaining an object feature vector of a target object, a historical playback sequence of the target object in a preset historical time period, and a video multi-target vector index of each video in a video library; obtaining an object enhanced vector of the target object by performing vectorization processing on the historical playback sequence; obtaining an object multi-target vector of the target object by sequentially performing vector concatenation processing and multi-target feature learning on the object feature vector and the object enhanced vector; determining, from the video library based on the object multi-target vector and the video multi-target vector index of each video, a target recommended video corresponding to the target object; and performing video recommendation to the target object based on the target recommended video.

Another embodiment of the present disclosure provides an electronic device. The electronic device includes a memory configured to store executable instructions; and one or more processors configured to execute the executable instructions stored in the memory and configured to perform: obtaining an object feature vector of a target object, a historical playback sequence of the target object in a preset historical time period, and a video multi-target vector index of each video in a video library; obtaining an object enhanced vector of the target object by performing vectorization processing on the historical playback sequence; obtaining an object multi-target vector of the target object by sequentially performing vector concatenation processing and multi-target feature learning on the object feature vector and the object enhanced vector; determining, from the video library based on the object multi-target vector and the video multi-target vector index of each video, a target recommended video corresponding to the target object; and performing video recommendation to the target object based on the target recommended video.

Another embodiment of the present disclosure provides a non-transitory computer-readable storage medium containing executable instructions that, when being executed, cause at least one processor to perform: obtaining an object feature vector of a target object, a historical playback sequence of the target object in a preset historical time period, and a video multi-target vector index of each video in a video library; obtaining an object enhanced vector of the target object by performing vectorization processing on the historical playback sequence; obtaining an object multi-target vector of the target object by sequentially performing vector concatenation processing and multi-target feature learning on the object feature vector and the object enhanced vector; determining, from the video library based on the object multi-target vector and the video multi-target vector index of each video, a target recommended video corresponding to the target object; and performing video recommendation to the target object based on the target recommended video.

### BRIEF DESCRIPTION OF THE DRAWINGS

FIG. 1 is a schematic diagram of a structure of a dual-tower structure.

FIG. 2 is a schematic diagram of a structure of a double-enhanced dual-tower structure.

FIG. 3 is a schematic diagram of an exemplary architecture of a video recommendation system according to an embodiment of the present disclosure.

FIG. 4 is a schematic diagram of a structure of an electronic device according to an embodiment of the present disclosure.

FIG. 5 is an exemplary schematic flowchart of a video recommendation method according to an embodiment of the present disclosure.

FIG. 6 is another exemplary schematic flowchart of a video recommendation method according to an embodiment of the present disclosure.

FIG. 7 is a schematic flowchart of a method for creating a video multi-target vector index according to an embodiment of the present disclosure.

FIG. 8 is a schematic flowchart of performing vectorization processing on a historical playback sequence according to an embodiment of the present disclosure.

FIG. 9 is a schematic flowchart of vector concatenation processing and multi-target feature learning according to an embodiment of the present disclosure.

FIG. 10 is a schematic flowchart of determining a target recommended video according to an embodiment of the present disclosure.

FIG. 11 is a schematic flowchart of a method for training a video recall model according to an embodiment of the present disclosure.

FIG. 12 is a schematic flowchart of obtaining sample data according to an embodiment of the present disclosure.

FIG. 13 is a schematic flowchart of determining a target loss result according to an embodiment of the present disclosure.

FIG. 14 is another schematic flowchart of determining a target loss result according to an embodiment of the present disclosure.

FIG. 15 is a schematic flowchart of determining an object enhanced loss and a video enhanced loss based on a multi-target network according to an embodiment of the present disclosure.

FIG. 16 is a diagram of an interface of a homepage of a video application according to an embodiment of the present disclosure.

FIG. 17 is a diagram of an interface of a material card according to an embodiment of the present disclosure.

FIG. 18 is a schematic flowchart of a calculation procedure according to an embodiment of the present disclosure.

FIG. 19 is a schematic diagram of a generation process of a feature vector according to an embodiment of the present disclosure.

FIG. 20 is a schematic diagram of a generation process of a user enhanced vector according to an embodiment of the present disclosure.

FIG. 21 is a schematic diagram of a structure of a PLE network according to an embodiment of the present disclosure.

FIG. 22 is a schematic flowchart of determining a similarity score according to an embodiment of the present disclosure.

FIG. 23 is a schematic flowchart of a training procedure according to an embodiment of the present disclosure.

FIG. 24 is a schematic diagram of an implementation procedure of selecting positive samples and negative samples according to an embodiment of the present disclosure.

FIG. 25 is a schematic diagram of an implementation procedure of an association feature according to an embodiment of the present disclosure.

FIG. 26 is a schematic diagram of a structure of an MMOE network according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all the possible embodiments, and can be combined with each other without conflict. Unless otherwise defined, meanings of all technical and scientific terms used in embodiments of the present disclosure are the same as those usually understood by a person skilled in the art to which embodiments of the present disclosure belongs. Terms used in embodiments of the present disclosure are merely intended to describe objectives of embodiments of the present disclosure, but are not intended to limit the present disclosure.

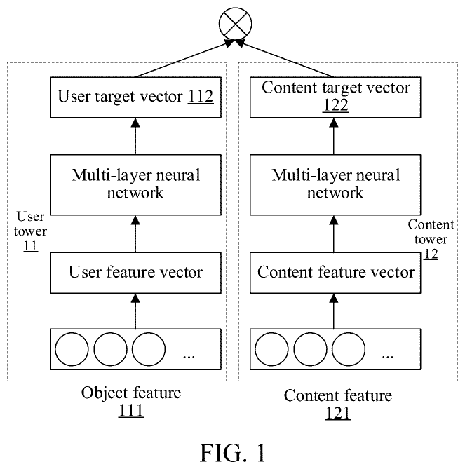

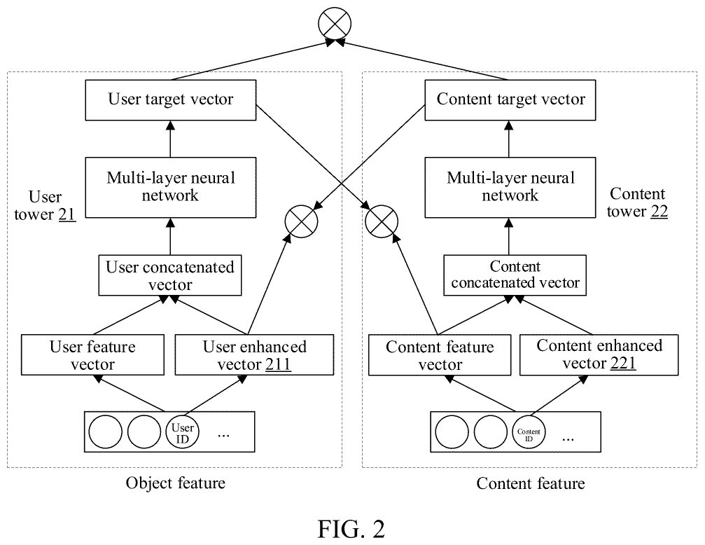

FIG. 1 is a schematic diagram of a structure of a dual-tower structure. As shown in FIG. 1, the dual-tower structure includes a user tower 11 for generating a user target vector and a content tower 12 for generating a content target vector. During offline training, an object feature 111 of a user is first inputted into the user tower 11, and a content feature 121 of content is inputted into the content tower 12. Then, an inner product of a user target vector 112 outputted by the user tower 11 and a content target vector 122 outputted by the content tower 12 is calculated. Similarity calculation is performed based on the inner product to obtain a similarity result between the user and the content, and the similarity result is used as a predicted value of the dual-tower structure. Finally, model parameters of the dual-tower structure can be continuously updated by reducing a loss function of a corresponding scenario target. In addition, a double-enhanced dual-tower structure is also provided. As shown in FIG. 2, the double-enhanced dual-tower structure generates a vector for fitting information of another tower at each of input layers of a user tower 21 and a content tower 22, respectively. The vector is referred to as an “enhanced vector”, namely a user enhanced vector 211 and a content enhanced vector 221. The enhanced vector is continuously updated by using a target vector of the another tower and is involved in a process of calculating the target vector.

Although the double-enhanced dual-tower structure can resolve the problem of insufficient cross-learning between user and the content to a some extent, the structure introduces the following problems: A parameter scale of the user enhanced vector is excessively large; a tower structure of the double-enhanced dual-tower structure can support prediction of a plurality of targets; and a plurality of target vectors cannot be fitted at the same time using the enhanced vector.

In view of at least one of the foregoing problems in the double-enhanced dual-tower structure, an embodiment of the present disclosure provides a video recommendation method. In the video recommendation method provided in this embodiment of the present disclosure, first, an object feature vector of a target object, a historical playback sequence of the target object in a preset historical time period, and a video multi-target vector index of each video in a video library are obtained. Then, vectorization processing is performed on the historical playback sequence to obtain an object enhanced vector of a target object, and vector concatenation processing and multi-target feature learning are sequentially performed on the object feature vector and the object enhanced vector to obtain an object multi-target vector of the target object. Finally, a target recommended video corresponding to the target object is determined from the video library based on the object multi-target vector and the video multi-target vector index of each video. In this way, the target object can be accurately analyzed with reference to information of the target object in a plurality of dimensions, so that video recall can be accurately performed. In addition, the object enhanced vector is generated based on the historical playback sequence of the target object, the historical playback sequence includes at least a playback record of videos played by the target object, and a quantity of playback records decreases apparently compared to a quantity of target objects that use a video application. Therefore, data calculation amount during video recall can be greatly reduced, so that efficiency of video recommendation can be greatly improved.

An exemplary application of a video recommendation device in an embodiment of the present disclosure is described below. The video recommendation device is an electronic device configured to implement the video recommendation method. In an implementation, the video recommendation device (that is, the electronic device) provided in this embodiment of the present disclosure may be implemented as a terminal or a server. In an implementation, the video recommendation device provided in this embodiment of the present disclosure may be implemented as any terminal having a video data processing function, such as a notebook computer, a tablet computer, a desktop computer, a mobile phone, a portable music player, a personal digital assistant, a messaging device, a potable game device, a smart robot, smart home appliance, or a smart vehicle-mounted device. In another implementation, the video recommendation device provided in this embodiment of the present disclosure may alternatively be implemented as a server. The server may be an independent physical server, a server cluster including a plurality of physical servers or a distributed system, or a cloud server providing a basic cloud computing service, such as a cloud service, a cloud database, cloud computing, a cloud function, a network service, cloud communication, a middleware service, a domain name service, a security service, a content delivery network (CDN), and a big data and artificial intelligence platform. The terminal and the server may be connected directly or indirectly in a wired or wireless communication manner, which is not limited in embodiments of the present disclosure. An exemplary application when the video recommendation device is implemented as a server is described below.

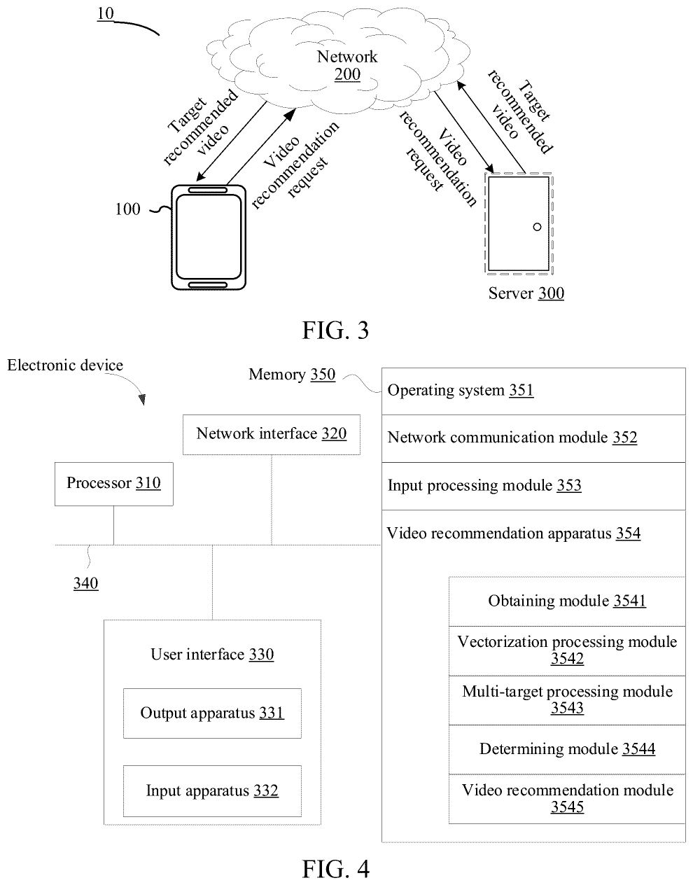

FIG. 3 is a schematic diagram of an exemplary architecture of a video recommendation system according to an embodiment of the present disclosure. An example in which the video recommendation method is applied in any video application is used for description in this embodiment of the present disclosure. The video application includes a plurality of selected pages and vertical channels. After scrolling/sliding down the selected pages and the vertical channels, a user may see a non-target region. The video recommendation method in embodiments of the present disclosure may be applied to recommendation of videos displayed in the non-target region. In this embodiment of the present disclosure, a video pushing system include at least a terminal 100, a network 200, and a server 300. The server 300 may be a server of a video application. The server 300 may constitute the video recommendation device in embodiments of the present disclosure The terminal 100 is connected to the server 300 through the network 200. The network 200 may be a wide area network, a local area network, or a combination of the two.

In this embodiment of the present disclosure, when video recommendation is performed, the terminal 100 receives a browsing operation (for example, the browsing operation may be a pull-down operation on any vertical channel) by a user through a client of the video application, obtains an object feature and a historical playback sequence of the user in response to the browsing operation, and encapsulates the object feature and historical playback sequence into a video recommendation request. The terminal 100 sends the video recommendation request to the server 300 through the network 200. After receiving the video recommendation request, the server 300 obtains the object feature and the historical playback sequence of the user in response to the video recommendation request, obtains an object feature vector of the user based on the object feature, and obtains a video multi-target vector index of each video in a video library. Then the server 300 performs vectorization processing on the historical playback sequence to obtain an object enhanced vector of a target object, and sequentially performs vector concatenation processing and multi-target feature learning on the object feature vector and the object enhanced vector to obtain an object multi-target vector of the target object. Next, the server 300 determines a target recommended video from the video library based on the object multi-target vector and the video multi-target vector index of each video. After obtaining the target recommended video, the server 300 sends the target recommended video to the terminal 100, so that the terminal 100 displays the target recommended video to the user on a non-target region of a current interface.

In some other embodiments, the video recommendation device may alternatively be implemented as a terminal. In other words, the video recommendation method in embodiments of the present disclosure is implemented by a terminal. During implementation, the terminal obtains a browsing operation by a user through a client of the video application, and obtains an object feature vector of the user, a historical playback sequence in a preset historical time period, and a video multi-target vector index of each video in a video library in response to the browsing operation. Then, the terminal recalls a target recommended video by using the video recommendation method in embodiments of the present disclosure, and after obtaining the target recommended video, displays the target recommended video to the user in a non-target region on a current interface.

The video recommendation method provided in embodiments of the present disclosure may alternatively be implemented based on a cloud platform and by using a cloud technology. For example, the foregoing server 300 may be a cloud server. The cloud server performed vectorization processing on a historical playback sequence. Alternatively, the cloud server sequentially performs vector concatenation processing and multi-target feature learning on an object feature vector and an object enhanced vector. In addition, the cloud server determines a target recommended video from a video library based on an object multi-target vector and a video multi-target vector index of each video.

In some embodiments, cloud storage may alternatively be provided. The video library and the video multi-target vector index of each video may be stored in the cloud storage, or the object feature vector of the user and the historical playback sequence in a preset historical time period may be stored in the cloud storage, or the target recommended video may be stored in the cloud storage. In this way, when a video recommendation request is received, corresponding information may be obtained from the cloud storage to recall the target recommended video, so that efficiency of recalling the target recommended video can be improved, thereby improving efficiency of video recommendation.

The cloud technology is a hosting technology that integrates resources such as hardware, software, and networks, to implement data computing, storage, processing, and sharing in a wide area network or a local area network. The cloud technology is a general term of network technologies, information technologies, integration technologies, management platform technologies, application technologies, and the like applied to a cloud computing business model, and may create a resource pool to satisfy what is needed in a flexible and convenient manner. A cloud computing technology is to be the backbone. A large quantity of computing resources and storage resources are needed for background services in a technical network system, such as video websites, picture websites, and other portal websites. With advanced development and application of the Internet technologies, all objects are likely to have their own identification flag in the future. These flags need to be transmitted to a background system for logical processing. Data of different levels is to be processed separately. Therefore, data processing in all industries requires support of a powerful system, and may be implemented through cloud computing.

FIG. 4 is a schematic diagram of a structure of an electronic device according to an embodiment of the present disclosure. The electronic device shown in FIG. 4 may be a video recommendation device. The video recommendation device includes: at least one processor 310, a memory 350, at least one network interface 320, and a user interface 330. The components in the video recommendation device are coupled together by using a bus system 340. The bus system 340 is configured to implement connection and communication between the components. In addition to a data bus, the bus system 340 further includes a power bus, a control bus, and a status signal bus. However, for clarity, various buses are marked as the bus system 340 in FIG. 4.

The processor 310 may be an integrated circuit chip having a signal processing capability, such as a general-purpose processor, a digital signal processor (DSP), or another programmable logic device, a discrete gate or a transistor logic device, or a discrete hardware component. The general-purpose processor may be a microprocessor, any conventional processor, or the like.

The user interface 330 includes one or more output apparatuses 331 that can render media content and one or more input apparatuses 332.

The memory 350 may be removable, non-removable, or a combination thereof. An exemplary hardware device includes a solid-state memory, a hard disk drive, an optical drive, and the like. The memory 350 may alternatively include one or more storage devices physically away from the processor 310. The memory 350 includes a volatile memory or a non-volatile memory, and may alternatively include both volatile and non-volatile memories. The non-volatile memory may be a read only memory (ROM), and the volatile memory may be a random access memory (RAM). The memory 350 described in this embodiment of the present disclosure is intended to include any suitable type of memories. In some embodiments, the memory 350 can store data to support various operations. Examples of the data include a program, a module, and a data structure, or a subset or a superset thereof. Descriptions are provided below by using examples.

An operating system 351 includes a system program used for processing various basic system services and performing hardware-related tasks, for example, a frame layer, a core library layer, and a drive layer, and is configured to implement various basic services and process a hardware-based task. A network communication module 352 is configured to reach another electronic device via one or more (wired or wireless) network interfaces 320. For example, the network interface 320 includes Bluetooth, wireless compatibility certification (Wi-Fi) a universal serial bus (USB), and the like. An input processing module 353 is configured to detect one or more user inputs or interactions from one of the one or more input apparatuses 332 and translate the detected inputs or interactions.

In some embodiments, an apparatus provided in an embodiment of the present disclosure may be implemented in a software manner. FIG. 4 shows a video recommendation apparatus 354 stored in the memory 350. The video recommendation apparatus 354 may be a video recommendation apparatus in the electronic device. The video recommendation apparatus may be software in a form of a program and a plug-in, and includes the following software modules: an obtaining module 3541, a vectorization processing module 3542, a multi-target processing module 3543, a determining module 3544, and a video recommendation module 3545. These modules are logical modules, and therefore may be combined in different manners or further divided based on a function to be implemented. The following describes the function of the modules.

In some other embodiments, the apparatus provided in this embodiment of the present disclosure may be implemented in a hardware manner. As an example, the apparatus provided in this embodiment of the present disclosure may be a processor in a form of a hardware decoding processor. The processor is programmed to perform the video recommendation method provided in embodiments of the present disclosure. For example, the processor in the form of a hardware decoding processor may use one or more application-specific integrated circuits (ASICs), DSPs, programmable logic devices (PLDs), complex programmable logic devices (CPLDs), field-programmable gate arrays (FPGAs), or other electronic components.

The video recommendation method provided in embodiments of the present disclosure may be performed by an electronic device. The electronic device may be a server or a terminal. In other words, the video recommendation method in embodiments of the present disclosure may be performed by a server or a terminal, or may be performed through interaction between a terminal and a server.

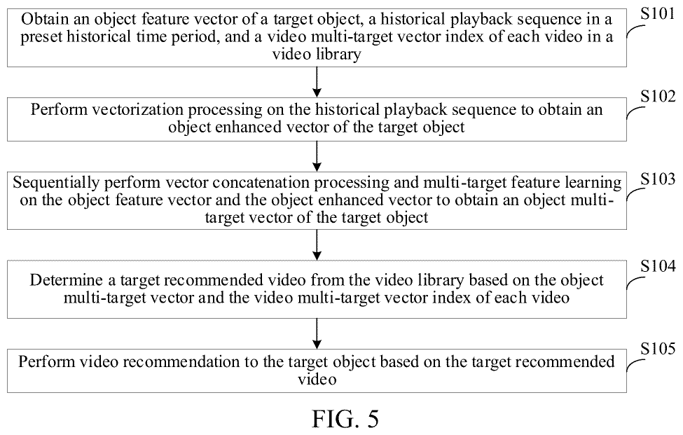

FIG. 5 is an exemplary schematic flowchart of a video recommendation method according to an embodiment of the present disclosure. Descriptions are provided below with reference to operations shown in FIG. 5. An example in which the video recommendation method in FIG. 5 is performed by a server is used for description. As shown in FIG. 5, the method includes the following operation S101 to operation S105.

Operation S101: Obtain an object feature vector of a target object, a historical playback sequence in a preset historical time period, and a video multi-target vector index of each video in a video library.

Herein, the object feature vector is obtained through vectorization processing on an object feature of the target object. The object feature of the target object includes but is not limited to at least one of the following: age, gender, education background, tag, video browsing history, interests, and the like of the target object. The vectorization processing may be performed on the object feature through feature extraction.

The vectorization processing is to search a feature vector corresponding to each object feature of a target object in a preset feature vector list through searching the preset feature vector list. The preset feature vector list may pre-store the feature vector corresponding to each object feature, and after the target object and a plurality of object features of the target object are determined, corresponding feature vectors may be queries from the preset feature vector list by using the plurality of object features as retrieval indexes. In this embodiment of the present disclosure, during the vectorization processing, query may be performed on the preset feature vector list, and the feature vector corresponding to each object feature is queried from the preset feature vector list to obtain the object feature vector of the target object. During implementation, because the object feature includes a plurality of pieces of feature information, a feature vector corresponding to each feature information may be queried from the preset feature vector list, and then the feature vectors corresponding to all of the feature information are concatenated to form a multi-dimension object feature vector.

The preset feature vector list may include two dimensions. The first dimension includes feature identifiers, and the second dimension includes vectors corresponding to the feature identifiers. Vector lists of different features are independent from each other. In other words, target objects (for example, users) may have an object feature vector list, and videos may have a video feature vector list. An object feature vector of a target object and a video feature vector of a video may be queried based on the object feature vector list and the video feature vector list respectively.

In this embodiment of the present disclosure, the object feature includes both discrete features and continuous features. Therefore, during the vectorization processing, for the discrete features, feature vectors of the discrete features may be obtained through directly querying the feature vector list; for the continuous features, discretization processing may be first performed on the continuous features to obtain discretized features, and feature vectors corresponding to the discretized features may be obtained through querying the feature vector list. Herein, the discretization processing may be to perform equal-frequency division on the continuous features by using specific equal-frequency division range to obtain a plurality of discretized features.

In this embodiment of the present disclosure, a feature vector list may be pre-constructed for feature vector query. The pre-constructed feature vector list may be stored in a preset storage unit. During the vectorization processing, the feature vector list is obtained from the preset storage unit for feature vector query. In some embodiments, the feature vector list may be updated based on an update of a video recall model and an update of the feature information. For example, when there is new feature information, a feature vector of the feature information is obtained, and the feature vector is updated into the feature vector list.

The historical playback sequence is a video sequence played by the target object (for example, a user) in a preset historical time period. The historical playback sequence includes a historical video identifier of a historically played video and historical playback duration of each historically played video.

The video library includes a plurality of videos. The video include a video that a user may be interested in and a video that the user is uninterested in. The video library may include a large number of candidate videos (in other words, a quantity of the candidate videos in the video library is greater than a video quantity threshold). The video recommendation method in this embodiment of the present disclosure is to accurately select a video that the user is interested in from the large number of candidate videos, and recommend the video that the user is interested in to the user as a target recommended video.

Each video has one video multi-target vector index. The video multi-target vector index is used for querying index information of a video multi-target vector of the video. In this embodiment of the present disclosure, a video multi-target vector of each video may be pre-generated. After the video multi-target vector is generated, video multi-target vectors of all videos are stored in a preset video multi-target vector storage unit. In addition, during storage of the video multi-target vector, index information corresponding to each video multi-target vector may alternatively be generated. The index information is configured for retrieving a storage location of the video multi-target vector, so that the video multi-target vector can be obtained based on the video multi-target vector index.

In this embodiment of the present disclosure, a video multi-target vector of each video can be generated before video recommendation, or the video multi-target vector of a video is generated while generating the video, and a video multi-target vector index of the video multi-target vector is created and the video multi-target vector of the video can be queried in time and online based on the video multi-target vector index, without needing to generate the video multi-target vector during each video recommendation. In other words, there is no need to repeatedly generate the video multi-target vector, so that data calculation amount during the video recommendation can be greatly reduced, thereby improving efficiency of video recommendation.

Operation S102: Perform vectorization processing on the historical playback sequence to obtain an object enhanced vector of the target object.

Herein, during the vectorization processing on the historical playback sequence, query may be performed on the preset feature vector list, and a feature vector corresponding to each piece of sequence information in the historical playback sequence is queried from the preset feature vector list to obtain the object enhanced vector of the target object. During implementation, because the historical playback sequence includes a plurality of pieces of sequence information, and each piece of sequence information includes a video identifier of a historically played video and playback duration of each historically played video, a feature vector corresponding to the video identifier and a feature vector corresponding to the playback duration may be queried.

In this embodiment of the present disclosure, the vectorization processing on the historical playback sequence may be implemented in the following manners: first, for each historical video identifier in the historical playback sequence, searching the preset feature vector list, in other words, searching the preset feature vector list based on each historical video identifier to obtain a historical video vector set, where a quantity of historical video vectors in the historical video vector set is the same as a quantity of the historical video identifiers in the historical playback sequence; then, calculating the total of the historical playback duration in the historical playback sequence to obtain total historical playback duration, in other words, calculating the total duration of the historical playback sequence, where the historical playback duration in all of the sequence information may be summed to obtain the total historical playback duration, each historical playback duration in the historical playback sequence is divided by the total historical playback duration to obtain normalized playback duration corresponding to each historical playback duration, the normalized playback duration is used as a video vector weight, and a quantity of the video vector weights is also the same as the quantity of the historical video identifiers in the historical playback sequence; and finally, multiplying each historical video vector in the historical video vector set by a corresponding video vector weight to obtain a video weighted vector set, and combining all of video weighted vectors in the video weighted vector set to obtain the object enhanced vector of the target object, that is, to obtain a user enhanced vector. Herein, combining all of the video weighted vectors in the video weighted vector set may be performing concatenation processing on all of the video weighted vectors in the video weighted vector set to obtain the multi-dimension user enhanced vector. A dimension of the user enhanced vector equals to a sum of dimensions of all of the video weighted vectors.

Operation S103: Sequentially perform vector concatenation processing and multi-target feature learning on the object feature vector and the object enhanced vector to obtain an object multi-target vector of the target object.

Herein, performing the vector concatenation processing and the multi-target feature learning on the object feature vector and the object enhanced vector may be first performing the vector concatenation processing on the object feature vector and the object enhanced vector to obtain an object concatenated vector, and then performing the multi-target feature learning on the object concatenated vector.

In this embodiment of the present disclosure, performing the vector concatenation processing on the object feature vector and the object enhanced vector may obtain the object concatenated vector. The object concatenated vector is a concatenated vector that fuses the object feature vector and the object enhanced vector of the target object. A dimension of the object concatenated vector equals to a sum of dimensions of the object feature vector and the object enhanced vector.

After the vector concatenation processing is performed, the multi-target feature learning is performed on the object concatenated vector. Herein, the multi-target feature learning is to learn object target vectors of the object concatenated vector in different target dimensions by using a pre-trained multi-target neural network. Different target dimensions include, but are not limited to: a click/tap dimension related to user click/tap behavior and a duration dimension related to browsing duration of the user. In this embodiment of the present disclosure, a click/tap target vector in the click/tap dimension and a duration target vector in the duration dimension of the target object may be learned by using the multi-target neural network to obtain the object multi-target vector of the target object.

In some embodiments, the multi-target neural network may be implemented as a PLE network. The PLE network mainly includes: an expert network used for learning a plurality of targets, a sharing network used for learning shared information between different expert networks, and a gate network used for calculating a weight corresponding to each vector during fusion of output vectors of a plurality of networks. For example, if two targets of click/tap and duration need to be learned, two groups of expert networks are needed. There is one sharing network regardless of the quantity of targets that need to be learned. A length of the last layer of output vectors of the gate network is the same as a quantity of to-be-determined weights.

Operation S104: Determine a target recommended video from the video library based on the object multi-target vector and the video multi-target vector index of each video.

Herein, a video multi-target vector of the video may be obtained based on a video multi-target vector index of the video, then an inner product of the object multi-target vector and the video multi-target vector is calculated, and the inner product obtained through calculation is determined a similarity score between the target object and the corresponding video. Then, the target recommended video is determined from the video library based on the similarity scores.

During determining of the target recommended video, in an implementation, a video having a similarity score higher than a score threshold is selected as the target recommended video; and in another implementation, ordering is performed on the videos in the video library based on the similarity scores to form a video sequence, and then the first N videos are selected from the video sequence as the target recommended videos. N is an integer greater than or equal to 1.

Operation S105: Perform video recommendation to the target object based on the target recommended video.

After obtaining the target recommended video, the server may send the target recommended video to a terminal, and the terminal recommends the target recommended video to the target object. In this embodiment of the present disclosure, the target recommended video may be displayed on the terminal of the target object. For example, the target recommended video may be displayed on a client of a video application.

In the video recommendation method provide in this embodiment of the present disclosure, vectorization processing is performed on a historical playback sequence of a target object to obtain an object enhanced vector of the target object, for obtaining an object multi-target vector of the target object based on the object enhanced vector of the target object. The object multi-target vector is an object feature vector fusing the object enhanced vector. In this way, in determining a target recommended video from a video library based on the object multi-target vector and a video multi-target vector index of each video, the target object can be accurately analyzed with reference to information of the target object in a plurality of dimensions, so that video recall can be accurately performed. In addition, the object enhanced vector is generated based on the historical playback sequence of the target object, the historical playback sequence is a playback record of videos played by the target object, and a quantity of playback records decreases apparently compared to a quantity of target objects that use a video application. Therefore, data calculation amount during video recall can be greatly reduced, so that efficiency of video recommendation can be greatly improved.

In some embodiments, the video recommendation system includes at least a terminal and a server, and a video application is installed on the terminal. When a user performs a pull-to-refresh and page pull-down operation on the video application, a target recommended video may be recalled by using the method in this embodiment of the present disclosure, and the target recommended video is display on a current interface of the video application, to implement video recommendation for a user.

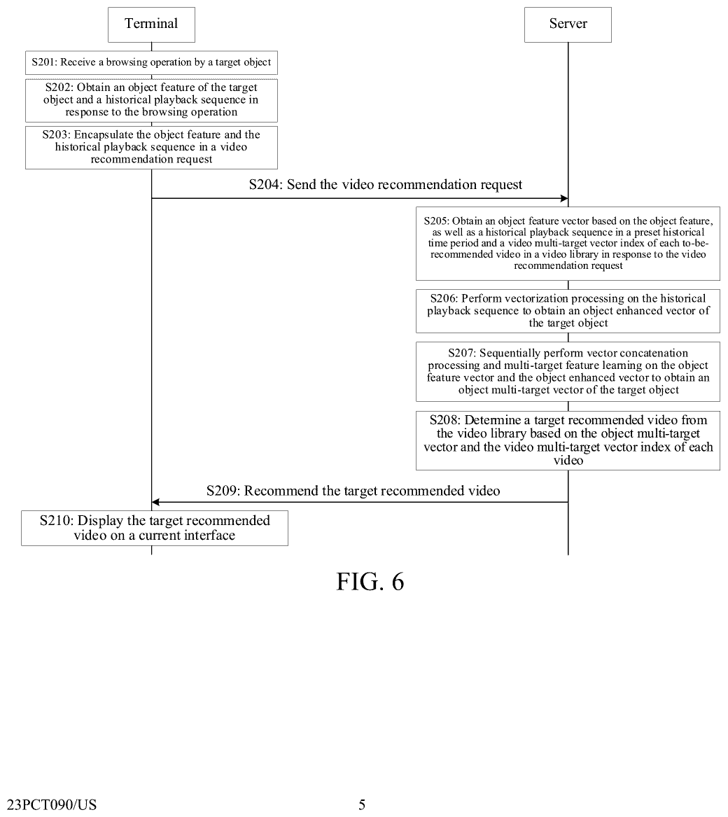

FIG. 6 is another exemplary schematic flowchart of a video recommendation method according to an embodiment of the present disclosure. As shown in FIG. 6, the method includes the following operation S201 to operation S210.

Operation S201: A terminal receives a browsing operation by a target object.

Herein, the browsing operation may be a pull-down operation on any vertical channel of a video application. The client of the video application may receive the pull-down operation by a user to obtain the browsing operation.

Operation S202: The terminal obtains an object feature of the target object and a historical playback sequence in response to the browsing operation.

Herein, when the browsing operation is obtained, the client obtains the object feature of the target object and the historical playback sequence. The object feature may be information inputted by the user during registration and use of the video application, and a server of the video application stores such information and uses the information as the object feature of the target object. During use of the video application by the user, the server of the video application collects playback records of the user. Each playback record includes a video identifier, playback time, and playback duration of a played video. Playback records in a preset historical time period may be selected based on the playback time to form a historical playback sequence.

The preset historical time period may be a specific time period before current time, for example, a preset historical time period such as one month or a half year before the current time.

Operation S203: The terminal encapsulates the object feature and the historical playback sequence in a video recommendation request.

Operation S204: The terminal sends the video recommendation request to the server.

Operation S205: The server obtains an object feature vector based on the object feature, as well as a historical playback sequence in a preset historical time period, and a video multi-target vector index of each video in a video library in response to the video recommendation request.

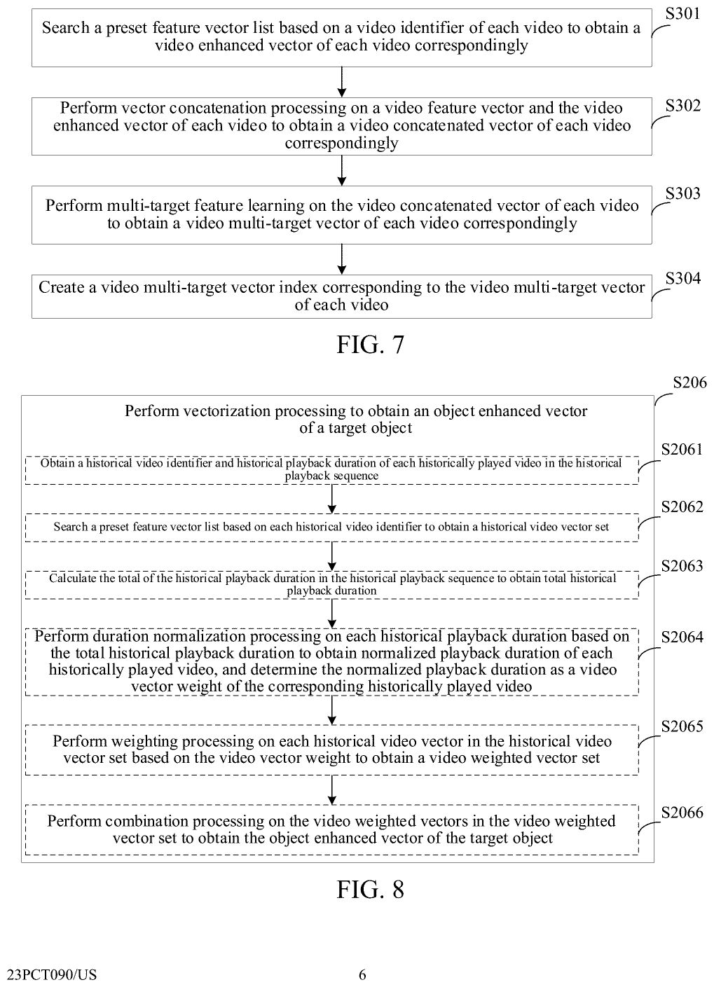

In some embodiments, before obtaining the video multi-target vector index of each video in the video library in operation S205, a video multi-target vector of each video in the video library may alternatively be pre-generated, and the video multi-target vector index of each video is created and stored. In this way, during subsequent recall of the target recommended video, a video multi-target vector may be queried based on the video multi-target vector index without needing to generate the video multi-target vector of the video, so that efficiency of recalling the target recommended video can be greatly improved. In view of this, an embodiment of the present disclosure provides a method for creating a video multi-target vector index. FIG. 7 is a schematic flowchart of a method for creating a video multi-target vector index according to an embodiment of the present disclosure. As shown in FIG. 7, the method for creating a video multi-target vector index may be performed by a server, and the method includes the following operation S301 to operation S304.

Operation S301: Search a preset feature vector list based on a video identifier of each video to obtain a video enhanced vector of each video correspondingly.

Herein, the preset feature vector list may be searched based on the video identifier of each video to obtain the video enhanced vector of each video.

The preset feature vector list includes two dimensions. The first dimension includes feature identifiers, and the second dimension includes vectors corresponding to features. Vector lists of different features are independent from each other. In other words, target objects (for example, users) may have an object feature vector list, and videos may have a video feature vector list. An object feature vector of a target object and a video feature vector of a video may be queried based on the object feature vector list and the video feature vector list respectively.

Operation S302: Perform vector concatenation processing on a video feature vector and the video enhanced vector of each video to obtain a video concatenated vector of each video correspondingly.

In this embodiment of the present disclosure, a method for generating the video feature vector is the same as a method for generating the object feature vector of foregoing target object, and the video feature vector may be queried based on the video feature vector list to obtain the video feature vector of the video.

Herein, the vector concatenation processing may be performed on the video feature vector and the video enhanced vector. During the vector concatenation processing, the video feature vector and the video enhanced vector are concatenated as a vector having a higher dimension, that is, a video concatenated vector. The dimension of the video concatenated vector equals to a sum of dimensions of the video feature vector and the video enhanced vector.

Operation S303: Perform multi-target feature learning on the video concatenated vector of each video to obtain a video multi-target vector of each video correspondingly.

In some embodiments, the multi-target feature learning on the video concatenated vector of each video may be implemented in the following manners: first, performing, for each video, the multi-target feature learning on the video concatenated vector of the video by using a multi-target neural network to obtain video target vectors of the video in a plurality of target dimensions; then, obtaining a target weight in each target dimension; performing weighting calculation on the video target vector in each target dimension by using the target weight to obtain a weighted video target vector; and finally, performing concatenation processing on the weighted video target vectors in the plurality of target dimensions to obtain the video multi-target vector of the video.

Herein, an example in which the foregoing plurality of target dimensions include a click/tap dimension and a duration dimension is used for description. In this embodiment of the present disclosure, a video click/tap target vector in the click/tap dimension and a video duration target vector in the duration dimension (the video click/tap target vector and the video duration target vector constitute the video target vector of the video) of the video may be outputted by using the multi-target neural network. The video has a click/tap target weight in the click/tap dimension and a duration target weight in the duration dimension. During the concatenation processing, a product of the click/tap target weight and the video click/tap target vector and a product of the duration target weight and the video duration target vector are separately calculated, and the two products are summed to obtain the video multi-target vector of the video. In other words, weighted summation is performed on the video click/tap target vector and the video duration target vector based on the click/tap target weight and the duration target weight to obtain the video multi-target vector.

The click/tap target weight and the duration target weight are all parameters in a video recall model. A method for updating the click/tap target weight and the duration target weight is described below.

Operation S304: Create the video multi-target vector index corresponding to the video multi-target vector of each video.

In this embodiment of the present disclosure, the video multi-target vector index is used for querying index information of the video multi-target vector of the video. After the video multi-target vector of each video is obtained, video multi-target vectors of all videos are stored in a preset video multi-target vector storage unit. During storage of the video multi-target vector, index information corresponding to each video multi-target vector may alternatively be generated. The index information is configured for retrieving a storage location of the video multi-target vector, so that the video multi-target vector can be obtained based on the video multi-target vector index.

In this embodiment of the present disclosure, the video multi-target vector of the video can be queried in time and online based on the video multi-target vector index, without needing to generate the video multi-target vector during each video recommendation. In other words, there is no need to repeatedly generate the video multi-target vector, so that data calculation amount during the video recommendation can be greatly reduced, thereby improving efficiency of video recommendation.

Operation S206: The server performs vectorization processing on the historical playback sequence to obtain an object enhanced vector of the target object.

In some embodiments, FIG. 8 shows that operation S206 may be implemented through the following operation S2061 to operation S2066.

Operation S2061: Obtain a historical video identifier and historical playback duration of each historically played video in the historical playback sequence.

Operation S2062: Search a preset feature vector list based on each historical video identifier to obtain a historical video vector set.

A quantity of historical video vectors in the historical video vector set is the same as a quantity of the historical video identifiers in the historical playback sequence.

Operation S2063: Calculate the total of the historical playback duration in the historical playback sequence to obtain total historical playback duration.

Herein, a sum of historical playback duration all of historically played videos in the historical playback sequence may be calculated to obtain the total historical playback duration.

Operation S2064: Perform duration normalization processing on each historical playback duration based on the total historical playback duration to obtain normalized playback duration of each historically played video, and determine the normalized playback duration as a video vector weight of the corresponding historically played video.

Herein, the normalization processing may be performing normalization processing on each historical playback duration based on the total historical playback duration. During implementation, each historical playback duration may be divided by the total historical playback duration, and a quotient value obtained through calculation is determined as the normalized playback duration of each historically played video. After the normalized playback duration corresponding to each historically played video is obtained, the normalized playback duration is determined as a video vector weight of the historically played video.

Operation S2065: Perform weighting processing on each historical video vector in the historical video vector set based on the video vector weight to obtain a video weighted vector set.

The historical video vector set includes historical video vectors corresponding to all of the historically played videos. Each historical video vector in the historical video vector set is multiplied by a corresponding video vector weight to obtain a plurality of video weighted vectors. The plurality of video weighted vectors constitute the video weighted vector set.

Operation S2066: Perform combination processing on the video weighted vectors in the video weighted vector set to obtain the object enhanced vector of the target object.

Herein, the combination processing is to concatenate all of the video weighted vectors in the video weighted vector set into a vector having a higher dimension. The vector having a higher dimension is the object enhanced vector. The dimension of the object enhanced vector is equal to a sum of dimensions of all of the video weighted vectors.

Operation S207: The server sequentially performs vector concatenation processing and multi-target feature learning on the object feature vector and the object enhanced vector to obtain an object multi-target vector of the target object.

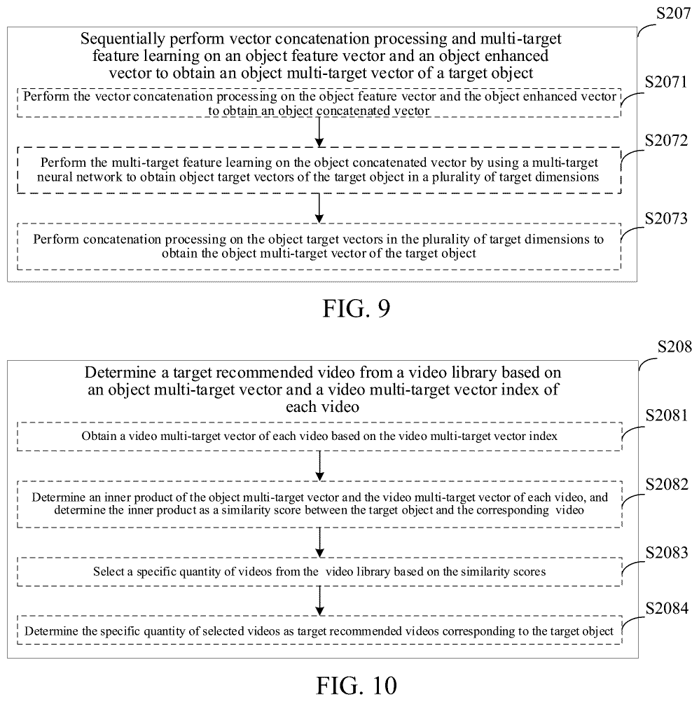

In some embodiments, FIG. 9 shows that operation S207 may be implemented through the following operation S2071 to operation S2073.

Operation S2071: Perform the vector concatenation processing on the object feature vector and the object enhanced vector to obtain an object concatenated vector.

The object concatenated vector is a concatenated vector of the target object fusing the object feature vector and the object enhanced vector. A dimension of the object concatenated vector is equal to a sum of dimensions of the object feature vector and the object enhanced vector.

Operation S2072: Perform the multi-target feature learning on the object concatenated vector by using a multi-target neural network to obtain object target vectors of the target object in a plurality of target dimensions.

The multi-target feature learning is to learn object target vectors of the object concatenated vector in different target dimensions by using a pre-trained multi-target neural network. Different target dimensions include, but are not limited to: a click/tap dimension related to user click/tap behavior and a duration dimension related to browsing duration of the user.

Operation S2073: Perform concatenation processing on the object target vectors in the plurality of target dimensions to obtain the object multi-target vector of the target object.

In this embodiment of the present disclosure, a click/tap target vector and a duration target vector of the target object may be learned by using the multi-target neural network, and then the click/tap target vector and the duration target vector are concatenated to obtain the object multi-target vector of the target object.

Operation S208: The server determines a target recommended video from the video library based on the object multi-target vector and the video multi-target vector index of each video.

In some embodiments, FIG. 10 shows that operation S208 may be implemented through the following operation S2081 to operation S2084.

Operation S2081: Obtain a video multi-target vector of each video based on the video multi-target vector index.

Herein, a storage location of the video multi-target vector of each video may be determined based on the video multi-target vector index, and then the stored video multi-target vector is obtained from the storage location.

Operation S2082: Determine an inner product of the object multi-target vector and the video multi-target vector of each video, and determine the inner product as a similarity score between the target object and the corresponding video.

In this embodiment of the present disclosure, the inner product of the object multi-target vector and the video multi-target vector of each video in the video library may be calculated to obtain the similarity score between the target object and each video.

Operation S2083: Select a specific quantity of videos from the video library based on the similarity scores.

Operation S2084: Determine the specific quantity of selected videos as target recommended videos corresponding to the target object.

Operation S209: The server recommends the target recommended video to the terminal.

Operation S210: The terminal displays the target recommended video on a current interface.

According to the video recommendation method provided in this embodiment of the present disclosure, in determining a target recommended video from a video library based on an object multi-target vector and a video multi-target vector index of each video, a target object can be accurately analyzed with reference to information of the target object in a plurality of dimensions, so that video recall can be accurately performed. In addition, the object enhanced vector is generated based on the historical playback sequence of the target object, the historical playback sequence is a playback record of videos played by the target object, and a quantity of playback records decreases apparently compared to a quantity of target objects that use a video application. Therefore, data calculation amount during video recall can be greatly reduced, so that efficiency of video recommendation can be greatly improved.

In some embodiments, the foregoing video recommendation method may be implemented by using a video recall model. The video recall model includes an object tower and a video tower. The object tower is a neural network structure used for determining an object multi-target vector (that is, a user multi-target vector), and the video tower is a neural network structure used for determining a video multi-target vector.

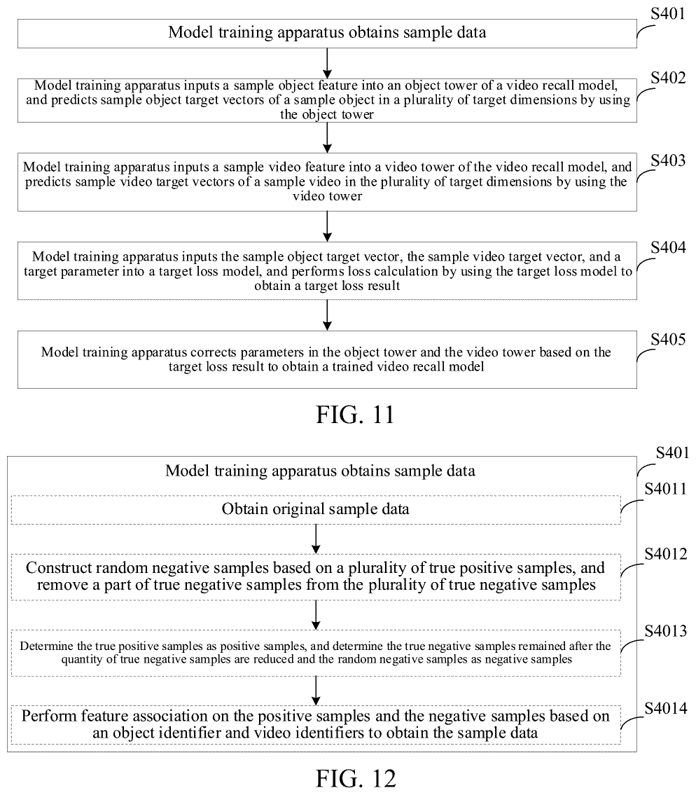

FIG. 11 is a schematic flowchart of a method for training a video recall model according to an embodiment of the present disclosure. The method for training a video recall model may be performed by a model training apparatus. The model training apparatus may be an apparatus in a video recommendation device (that is, an electronic device). In other words, the model training apparatus may be a server or a terminal. Alternatively, the model training apparatus may be another device independent to the video recommendation device. In other words, the model training apparatus is another electronic device different from the foregoing server and terminal configured to implement the video recommendation method. As shown in FIG. 11, the method for training a video recall model includes the following operation S401 to operation S405.

Operation S401: The model training apparatus obtains sample data.

Herein, the sample data includes: a sample object feature, a sample video feature, and target parameters in the plurality of target dimensions. The sample object feature and the sample video feature include but are not limited to a user identifier, a request identifier corresponding to a video recommendation request of a user. The sample video feature includes but is not limited to a video identifier. The target parameters in the plurality of target dimensions include, but are not limited to: whether a user clicks/taps a sample video, playback duration of the sample video, and the like.

In some embodiments, FIG. 12 shows that operation S401 may be implemented through the following operation S4011 to operation S4014.

Operation S4011: Obtain original sample data.

Herein, the original sample data includes a plurality of true positive samples and a plurality of true negative samples. The true positive sample is sample data corresponding to “actual exposure and playback behavior data”, and the true negative sample is sample data corresponding to “actual exposure without playback behavior data”.

Operation S4012: Construct random negative samples based on the plurality of true positive samples, and remove a part of true negative samples from the plurality of true negative samples.

Herein, in constructing the random negative samples, for each positive sample, a user identifier and a request identifier in the positive sample may be extracted from an entire video pool, then n video identifiers are randomly selected, and the n video identifiers are concatenated to form a negative sample, that is, to obtain the random negative sample.

Removing a part of true negative samples is to reduce a quantity of true negative samples. In reducing the quantity of true negative samples, a part of true negative samples may be randomly removed, or some true negative samples are randomly selected from all of the true negative samples.

In this embodiment of the present disclosure, after the random negative samples are constructed and a quantity of true negative samples are reduced, it is necessary to ensure that a quantity of the true positive samples, a quantity of the true negative samples remained after the part of true negative samples are removed, and a quantity of the random negative samples exhibit a preset proportional relationship. Herein, the preset proportional relationship may be determined based on a model parameter of the video recall model. For example, the preset proportional relationship may be 1:1:4. In other words, a quantity of true negatives samples obtained through random sampling is the same as a quantity of true positive samples. In addition, four videos are randomly selected from each positive sample as the random negative samples.

Operation S4013: Determine the true positive samples as positive samples, and determine the true negative samples remained, after the quantity of true negative samples are reduced and the random negative samples as negative samples.

Herein, the true positive samples are the positive samples for model training, and the true negative samples remained after the part of true negative samples are removed and the random negative samples jointly constitute the negative samples for model training.

Operation S4014: Perform feature association on the positive samples and the negative samples based on an object identifier and the video identifiers to obtain the sample data.

Herein, based on the selected positive samples and the negative samples, object features are associated by using the user identifiers and video features are associated by using the video identifiers to obtain the sample object feature and the sample video feature, and during subsequent model training, the sample object feature is inputted into an object tower (that is, a user tower), and the sample video feature is inputted into a video tower. The constructed sample object feature includes both positive samples and negative samples. The constructed sample video feature includes both positive samples and negative samples.

Operation S402: The model training apparatus inputs the sample object feature into an object tower of the video recall model, and predicts sample object target vectors of a sample object in the plurality of target dimensions by using the object tower.

Herein, the object tower may perform vectorization processing on the sample object feature to obtain a sample object feature vector. The object tower may alternatively generate a sample object enhanced vector, and sequentially perform vector concatenation processing and multi-target feature learning on the sample object feature vector and the sample object enhanced vector to obtain the sample object target vectors of the sample object in the plurality of target dimensions. In this way, a sample object multi-target vector of the sample object can be obtained through the concatenation processing on the sample object target vectors of the sample object in the plurality of target dimensions.

Operation S403: The model training apparatus inputs the sample video feature into a video tower of the video recall model, and predicts sample video target vectors of a sample video in the plurality of target dimensions by using the video tower.

Herein, the video tower may perform vectorization processing on the sample video feature to obtain a sample video feature vector. The video tower may alternatively generate a sample video enhanced vector, and sequentially perform vector concatenation processing and multi-target feature learning on the sample video feature vector and the sample video enhanced vector to obtain the sample video target vectors of the sample video in the plurality of target dimensions. In this way, a sample video multi-target vector of the sample video can be obtained through the concatenation processing on the sample video target vectors of the sample video in the plurality of target dimensions.

Then a sample similarity score between the sample object and the sample video can be determined through calculating an inner product of the sample object multi-target vector and sample video multi-target vector.

Operation S404: The model training apparatus inputs the sample object target vector, the sample video target vector, and the target parameter into a target loss model, and performs loss calculation by using the target loss model to obtain a target loss result.

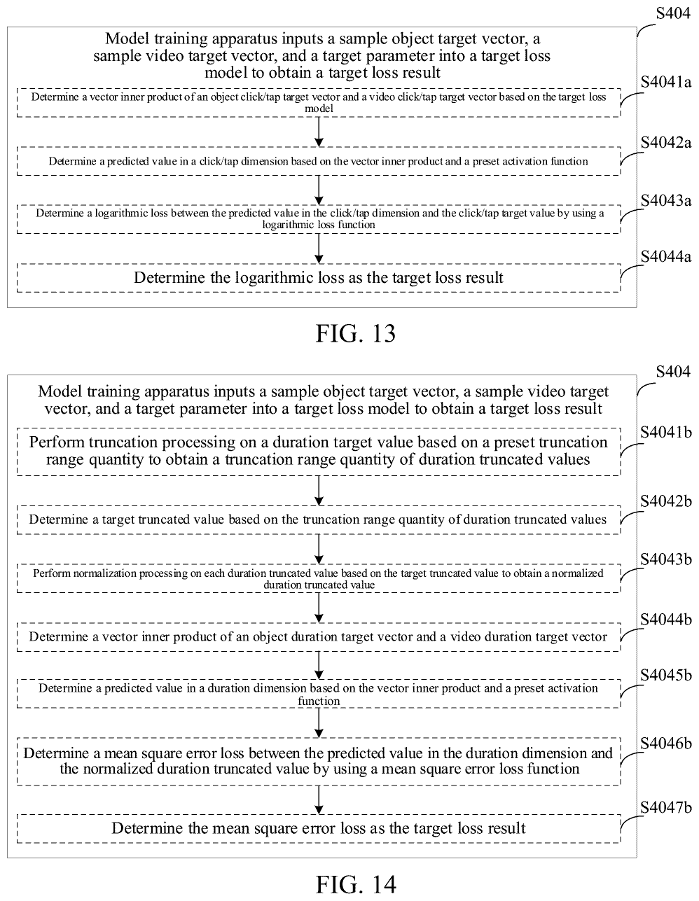

In an implementation, the sample object target vector includes an object click/tap target vector; the sample video target vector includes a video click/tap target vector; and the target parameter includes a click/tap target value. FIG. 13 shows that operation S404 may be implemented through the following operation S4041a to operation S4044a.

Operation S4041a: Determine a vector inner product of the object click/tap target vector and the video click/tap target vector based on the target loss model.

Operation S4042a: Determine a predicted value in a click/tap dimension based on the vector inner product and a preset activation function.

Herein, the vector inner product may be inputted into the preset activation function, and calculation is performed on the vector inner product by using the preset activation function to obtain the predicted value in the click/tap dimension. The preset activation function may map the vector inner product into any value from 0 to 1. For example, the preset activation function can obtain a mapped value ranging from 0 to 1 based on the inputted vector inner product. The mapped value constitutes the predicted value in the click/tap dimension.

In an implementation, the preset activation function may be a sigmoid activation function. In this case, the vector inner product may be inputted into the sigmoid activation function to calculate the predicted value in the click/tap dimension by using the sigmoid activation function.

Operation S4043a: Determine a logarithmic loss between the predicted value in the click/tap dimension and the click/tap target value by using a logarithmic loss function.

Operation S4044a: Determine the logarithmic loss as the target loss result.

In another implementation, the sample object target vector includes an object duration target vector; the sample video target vector includes a video duration target vector; and the target parameter includes a duration target value. FIG. 14 shows that operation S404 may be implemented through the following operation S4041b to operation S4047b.

Operation S4041b: Perform truncation processing on the duration target value based on a preset truncation range quantity to obtain a truncation range quantity of duration truncated values.

For example, the preset truncation range quantity is 100, and the duration target value is t, then t is divided by 100 to obtain 100 duration truncated values.

Operation S4042b: Determine a target truncated value based on the truncation range quantity of duration truncated values.

Herein, a duration truncated value with minimum duration in 100 duration truncated values may be determined as the target truncated value.

Operation S4043b: Perform normalization processing on each duration truncated value based on the target truncated value to obtain a normalized duration truncated value.

Herein, the normalization processing is performed on each duration truncated value by using a MinMax function. Each duration truncated value may be divided by the target truncated value to obtain a normalized duration truncated value corresponding to the duration truncated value.

Operation S4044b: Determine a vector inner product of the object duration target vector and the video duration target vector.

Operation S4045b: Determine a predicted value in a duration dimension based on the vector inner product and a preset activation function.

Herein, the vector inner product of the object duration target vector and the video duration target vector may be inputted into the preset activation function, and calculation is performed on the vector inner product by using the preset activation function to obtain the predicted value in the duration dimension. In an implementation, the preset activation function herein may also be a sigmoid activation function. In this case, the vector inner product may be inputted into the sigmoid activation function to calculate the predicted value in the duration dimension by using the sigmoid activation function.

Operation S4046b: Determine a mean square error loss between the predicted value in the duration dimension and the normalized duration truncated value by using a mean square error loss function.

Operation S4047b: Determine the mean square error loss as the target loss result.

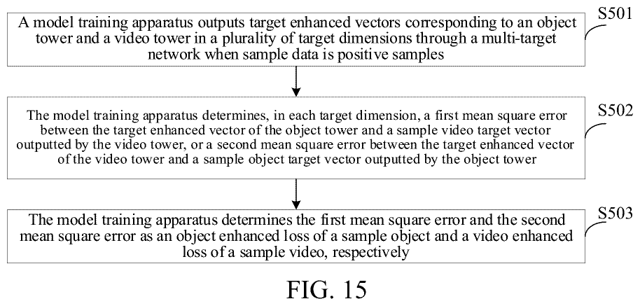

In some embodiments, the video recall model further includes a multi-target network, and calculation may be performed on the object enhanced loss of the sample object and the video enhanced loss of the sample video by using the multi-target network. FIG. 15 is a schematic flowchart of determining an object enhanced loss and a video enhanced loss based on a multi-target network according to an embodiment of the present disclosure. As shown in FIG. 15, the following operation S501 to operation S503 are included.

Operation S501: The model training apparatus outputs target enhanced vectors in the plurality of target dimensions through the multi-target network when the sample data is positive samples. The target enhanced vectors in the plurality of target dimensions include a target enhanced vector corresponding to the object tower and a target enhanced vector corresponding to the video tower.

Operation S502: The model training apparatus determines, in each target dimension, a first mean square error between the target enhanced vector corresponding to the object tower and the sample video target vector outputted by the video tower, or a second mean square error between the target enhanced vector corresponding to the video tower and the sample object target vector outputted by the object tower.

Operation S503: The model training apparatus determines the first mean square error and the second mean square error as an object enhanced loss of the sample object and a video enhanced loss of the sample video, respectively.

Herein, the object enhanced loss and the video enhanced loss are parts of the target loss result.

In this embodiment of the present disclosure, the target loss result includes a logarithmic loss in a click/tap dimension, a mean square error loss in a duration dimension, an object enhanced loss in the click/tap dimension, a video enhanced loss in the click/tap dimension, an object enhanced loss in the duration dimension, and a video enhanced loss in the duration dimension. In some embodiments, loss fusion processing may be performed on the plurality of losses, and retraining a model parameter correction are performed on the video recall model based on a fused loss result obtained through the loss fusion processing.

During implementation, loss weights respectively corresponding to the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension may be obtained, and a preset regularization term is obtained. Then, loss fusion processing is performed on the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension based on the loss weights and the regularization term to obtain a fused loss result. Finally, parameters in the object tower and the video tower are corrected based on the fused loss result to obtain a trained video recall model.

Operation S405: The model training apparatus corrects parameters in the object tower and the video tower based on the target loss result to obtain a trained video recall model.

In some embodiments, during performing of the multi-target feature learning on the video concatenated vector of each video, a target weight in each target dimension is obtained, and weighting calculation is performed on the video target vector in each target dimension based on the target weight.

Herein, a process of obtaining the foregoing target weights is described. The sample object target vector and the sample video target vector are inputted a recommendation prediction layer of the video recall model, and a click/tap parameter and a video duration parameter of the sample object in respect of the sample video are determined based on the recommendation prediction layer. Then, a performance indicator value of the video recall model is determined based on the click/tap parameter, and average top duration of the video recall model is determined based on the video duration parameter. Finally, a plurality of cyclic tests are performed based on the performance indicator value and the average top duration to obtain a target weight in the click/tap dimension and a target weight in the duration dimension.

In this embodiment of the present disclosure, the performance indicator value is an indicator value used for measuring quality of the video recall model, and the performance indicator value may be an AUC value of the video recall model. Herein, the area under curve (AUC) is defined as an area under a receiver operating characteristic curve (ROC). AUC is a performance indicator for measuring the quality of the video recall model. AUC can be obtained through summing areas of parts under the ROC curve.

Exemplary application of this embodiment of the present disclosure in a practical application scenario is described below.

According to the video recommendation method provided in embodiments of the present disclosure, in this embodiment of the present disclosure, an initialization method of a user enhanced vector can be optimized, and the user enhanced vector can be generated based on a user playback sequence. The user playback sequence is playback records of content (such as video) played by a user, and the playback record includes information such as content IDs and duration. Because there are only millions of content IDs in the user playback sequence, which are a hundred times less than a quantity of users, a process of generating the user enhanced vector based on the user playback sequence can significantly reduce a model size. Duration and content played by most users are different, and therefore, users can be differentiated. In addition, in this embodiment of the present disclosure, a structure of each tower can also be optimized, and a plurality of vectors corresponding to a plurality of targets are outputted by using a multi-target neural network. Moreover, in this embodiment of the present disclosure, a method for fitting the target vector using the enhanced vector is also optimized. Through adding a multi-gate mixture of experts (MMOE) network during fitting, a plurality of target vectors can be fitted at the same time using one enhanced vector.

According to the video recommendation method in embodiments of the present disclosure, a multi-target recall model (that is, a video recall model) based on a double-enhanced dual-tower structure is redesigned. Through a method in which the user enhanced vector (that is, the object enhanced vector) is initialized based on the historical playback sequence, a multi-target network is used as a tower structure to dynamically extract multi-target information of the enhanced vector, problems that a parameter scale of the user enhanced vector in an original structure is excessively large, the tower structure is only applicable to a single target, and the multi-target information cannot be fitted using the enhanced vector can be resolved. To further learn and predict a plurality of targets at the same time, in this embodiment of the present disclosure, at a training stage, a method for calculating target losses is optimized by performing processing such as truncation and normalization on the target value and the predicted value, and a method for fusing a plurality of target losses is optimized by adaptively learning weights of the target losses. In addition, at an application stage, by defining an evaluation formula, measurement scores of target similarities under different weight combinations are calculated, and the best combination that satisfies the plurality of targets at the same time is explored offline, so that a method for fusing a plurality of target similarities is optimized. After a series of optimizations, the video recall model in embodiments of the present disclosure finally has an ability to fully increase cross-learning opportunities between users and content (that is, videos) at an offline training stage in a recommendation scenario in which targets such as a click/tap rate and average playback duration per person are taken into consideration, and to quickly retrieve content that satisfies a plurality of targets in a balanced manner at an online application stage.

In embodiments of the present disclosure, in addition to constant vectorization on the object feature and the content feature, each of the user tower and the content tower of the video recall model has concatenated with an enhanced vector carrying multi-target information of another tower. After the concatenated vector is calculated by a multi-target tower, a total of four vectors are output, namely a user click/tap target vector, a content click/tap target vector, a user duration target vector, and a content duration target vector. The two user target vectors are directly concatenated as a user multi-target vector. The two content target vectors are multiplied by respective weights and concatenated together as a content multi-target vector. Then, an inner product of the user multi-target vector and the content multi-target vector is calculated online in real time, and the inner product is used as a similarity score. The higher the similarity score, the more interested the user is. The video recommendation system combines a retrieved top score result and another recalled result and performs deduplication, and then continues to perform logic operations such as fine sorting and mixed sorting to finally recommend videos to the user. An implementation process of video recall and recommendation by a video recall model in an embodiment of the present disclosure is described in detail below.

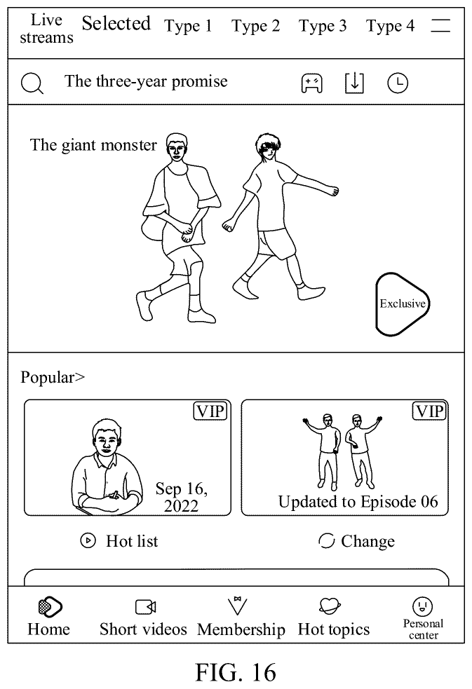

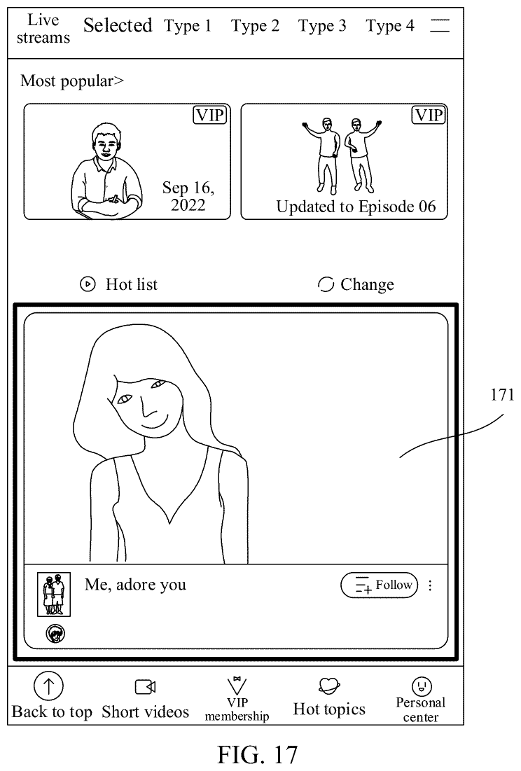

An application scenario of this embodiment of the present disclosure may be a recommendation waterfall flow of a material card in a non-destination region of each channel on a homepage of any video application. FIG. 16 is a diagram of an interface of a homepage of a video application. The homepage of the video application includes a plurality of channels, mainly a selected page and vertical channels. The selected page may comprehensively display content of various types (for example, the various types herein may be types such as TV series, movies, variety shows, and animations), such as type 1, type 2, type 3, and type 4. Each vertical channel only displays a corresponding type of content, for example, a TV series channel only displays TV series. A non-target region can be seen by a user after sliding down each channel, as shown in FIG. 17. A main content type is a material card 171, and videos that the user is interested in are displayed in a personalized manner through the material card 171. In the scenario of this embodiment of the present disclosure, whether the user finally clicks/taps is affected by many factors, for example, current time, long-term interests, and recent hot topics. In this case, technical difficulties of this embodiment of the present disclosure is how to retrieve videos that the user is really interested in based on limited information to increase a click/tap rate and average playback duration per person in the scenario. A main objective of this embodiments of the present disclosure is to retrieve videos that a user is interested in based on personalized information such as a feature and historical behavior of a target object (such as the user) while considering both click/tap and duration targets, and to display the videos of interest to the user through a recommendation service, to attract the user to click/tap and drive a growth in business indicators.

A core technology of this embodiment of the present disclosure includes: a calculation process based on the multi-target recall model (that is, a process of calculating a similarity score between a user and a video), a training process (that is, a process of updating a model parameter by using training data), and an application process (that is, a process of retrieving, in real time, videos that a user is interested in). The three processes are respectively described below.

The following describes the calculation process based on the multi-target recall model.

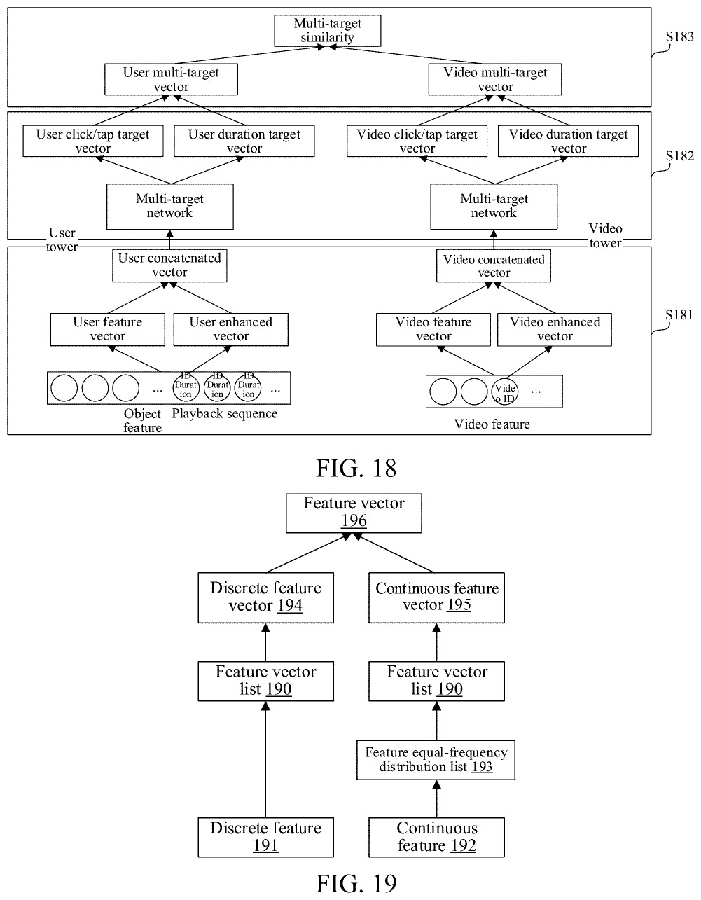

When accessing to a non-target region of each channel of a video application, a user sends a request for obtaining a video (that is, a video recommendation request) to a recommendation service, and the recommendation service returns the video of interest to the user (that is, a target recommended video) through logics such as recall, fine sorting, and mixed sorting. The video recall model in this embodiment of the present disclosure is located at a recall layer, and videos are retrieved through a calculation process shown in FIG. 18. The calculation process includes the following operations: Operation S181: Input a feature and perform vectorization. Operation S182: Output a multi-target vector. Operation S183: Calculates multi-target similarity.

In operation S181, the feature inputted into the model cannot be directly involved in the calculation and need to be vectorized. In addition to a feature vector, an enhanced vector used for increasing opportunities of interaction between a user and a video is also generated at this stage.

In this embodiment of the present disclosure, during generation of the feature vector, a method shown in FIG. 19 is used. The video recall model first inputs an object feature into a user tower and a video feature into a video tower, and then performs vectorization processing through a feature vector list 190 (that is, the foregoing preset feature vector list). The feature vector list has two dimensions. The first dimension includes feature IDs, and the second dimension includes vectors corresponding to the feature IDs. Vector lists of different features are independent from each other. For a discrete feature 191, the vector list includes: information related to a discrete type of a target object, an ID, a category, and a label of a video, and the like, and a corresponding vector list may be directly searched based on IDs. For a continuous feature 192, the vector list includes: hours from the last login time of a user, a quantity of videos played in the last 30 days, the last playback duration, duration of a video, days from the start of livestreaming, a click/tap rate, and the like, and discretization processing needs to be performed. For example, the discretization processing may be to determine a range within which the continuous feature 192 falls based on a feature equal-frequency distribution list 193 that is obtained through offline calculation, and then search the corresponding feature vector list 190 based on a range ID. The equal-frequency distribution statistics of each continuous feature are also independent. In this embodiment of the present disclosure, after searching the feature vector list 190 for the discrete feature 191 and the continuous feature 192, a discrete feature vector 194 and a continuous feature vector 195 are obtained respectively. Then, the discrete feature vector 194 and the continuous feature vector 195 are concatenated to form a feature vector 196. After being vectorized, the object feature and the video feature are concatenated internally to generate an object feature vector and a video feature vector. The feature vector list is a part of a model parameter. A method for updating the model parameter is described in the training process below.

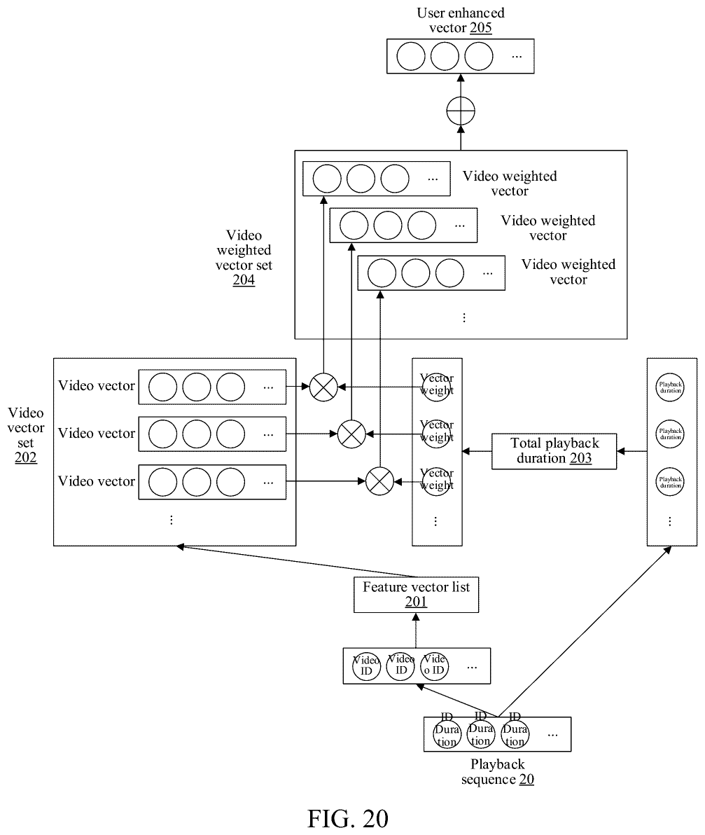

In this embodiment of the present disclosure, during generation of the enhanced vector, the enhanced vector includes a user enhanced vector and a video enhanced vector. The video enhanced vector is obtained through searching the feature vector list based on by a video ID, and the user enhanced vector is generated based on a playback sequence (that is, a historical playback sequence). As shown in FIG. 20, a playback sequence 20 includes IDs and duration of video historically played by a user. Herein, first, for each video ID in the playback sequence 20, the feature vector list 201 is searched to generate a video vector set 202. A quantity of video vectors in the video vector set 202 is the same as a quantity of video IDs in the playback sequence. Then, total playback duration 203 of the playback sequence is calculated, and each playback duration in the playback sequence is divided by the total playback duration 203 to obtain normalized duration as a video vector weight. A quantity of video vector weights is also the same as the quantity of video IDs in the playback sequence. Finally, each vector in the video vector set is multiplied by a corresponding video vector weight to obtain a video weighted vector set 204, and vectors in the video weighted vector set 204 are combined to obtain a user enhanced vector 205. The feature vector list at this stage is also a part of the model parameter. The method for updating the model parameter is described in the training process below.

In this embodiment of the present disclosure, the user enhanced vector is generated by using the playback sequence. Because duration and videos played by most users are different, and weighting is performed on vector by using playback duration in this embodiment of the present disclosure, differentiation processing can be performed on different users without affecting confidence of the user enhanced vector. A method for generating the user enhanced vector in this embodiment of the present disclosure has the following two advantages. First, although playback sequences of most users are different, the order of magnitude of video IDs covered by the playback sequences of the users remain unchanged, and the quantity is reduced by a hundred times compared to the hundreds of millions of users accumulated in the application scenario, so that computing resources and storage space of the model can be significantly saved. Second, assuming that a quantity of samples remains unchanged, because a quantity of video IDs in a playback sequence is much less than a quantity of users, each video ID can get more sufficient training opportunities, so that a more accurate user enhanced vector can be obtained.

In this embodiment of the present disclosure, during vector concatenation, the model concatenates, at an input layer of each of the user tower and the video tower, a generated feature vector and enhanced vector together to obtain a concatenated vector. The concatenated vectors obtained by the user tower and the video tower are used as a user concatenated vector and a video concatenated vector, respectively, and a subsequent process continues.

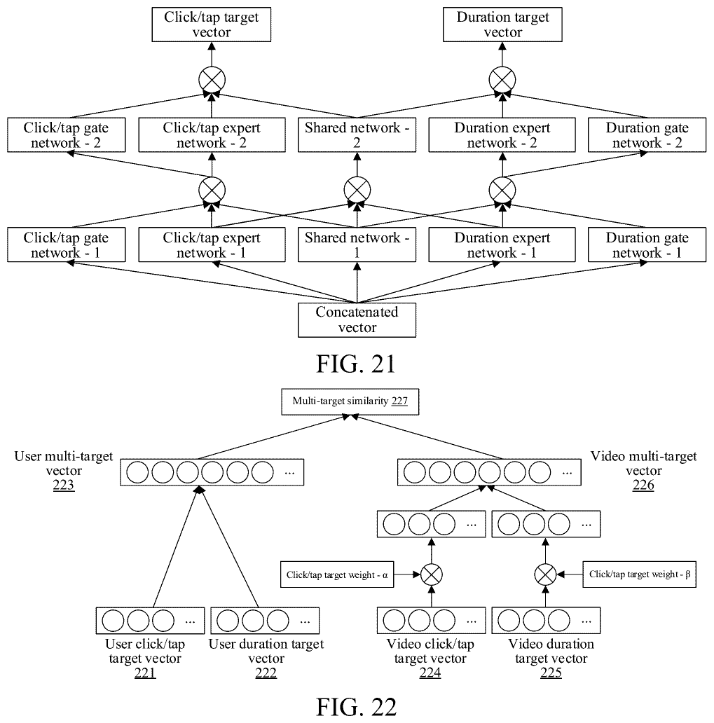

In operation S182, compared with an original double-enhanced dual-tower structure, structures of the user tower and the video tower in this embodiment of the present disclosure are both multi-target neural networks. For example, the multi-target neural network may be a progressive layered extraction (PLE) network. The PLE network (as shown in FIG. 21) mainly includes the following networks: (1) an expert network for learning a plurality of targets, where if, for example, two targets of click/tap and duration need to be learned, two groups of expert networks are need; (2) a sharing network for learning shared information between different expert networks, where there is one sharing network regardless of a quantity of targets that need to be learned; and (3) a gate network that is for calculating output vectors during fusion of a plurality of networks and that is of a weight corresponding to each vector, where a length of an output vector at the last layer of the gate network is the same as a quantity of to-be-determined weights. The expert network, the sharing network, and the gate network may be multi-layered, and each layer is a multi-layer neural network. Because an output of the last layer of the expert network is the target vector, and there is no need to interact with the sharing network and the gate network in the subsequence, the sharing network and the gate network have one less layer than the expert network. A specific quantity of layers may be determined by offline test. In this embodiment of the present disclosure, a three-layer expert network, a two-layer sharing network, and a two-layer gate network may be used. After the user concatenated vector and video concatenated vector in the previous operation pass through their respective PLE networks, a click/tap expert network outputs a click/tap target vector, and a duration expert network outputs a duration target vector, in other words, the two towers each output two vectors. A PLE network parameter is a part of the model parameter. The method for updating the model parameter is described in the training process below.

In operation S183, the PLE network is provided to optimize a fine sorting model in the recommendation. During score calculation, a predicted value of a click/tape rate being multiplied by a predicted value of the duration is equivalent to duration expectation of the user. A plurality of calculations are required in this method, and the method can be applied to cases in which there is a small quantity of candidate set. However, the recall model needs to deal with massive candidate sets and adopts a nearest neighbor algorithm that is more efficient. The score is generally the inner product that only needs to be calculated once. The score calculation method of the original structure cannot be applied to the recall model and needs to be redesigned.

The most intuitive method to calculate the multi-target similarity based on the inner product is to first calculate an inner product of a user click/tap target vector and a video click/tap target vector, as well as an inner product of a user duration target vector and a video duration target vector, and then perform weighted summation on the two inner products. However, this method also requires a plurality of calculations. The method in this embodiment of the present disclosure is to first concatenate a click/tap target vector and a duration target vector inside each tower. A difference lies in that the user click/tap target vector 221 and the user duration target vector 222 are directly concatenated in the user tower. The concatenated vector obtained through concatenation is used as a user multi-target vector 223. Each bit of the video click/tap target vector 224 in the video tower is multiplied by a click/tap target weight a, and each bit of a video duration target vector 225 is multiplied by a click/tap target weight B. Then concatenation is performed, and the concatenated vector obtained through concatenation is used as a video multi-target vector 226. Finally, an inner product of the user multi-target vector 223 and the video multi-target vector 226 is calculated as multi-target similarity 227 (that is, a similarity score) between the user and the video, as shown in FIG. 22. The higher the similarity score, the more interested the user is. In this embodiment of the present disclosure, the weighted summation of the click/tap target inner product and the duration target inner product can be implemented through one calculation, thereby adapting the nearest neighbor algorithm. α and β are parts of the model parameter. The method for updating the model parameter is described in the training process below.

The following describes the training process.

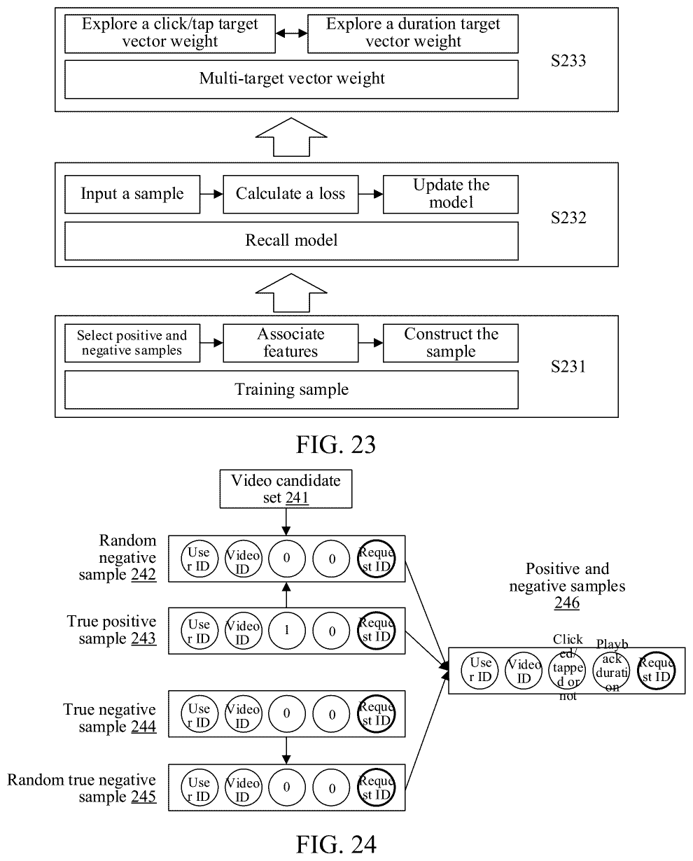

In this embodiment of the present disclosure, a video recall model is for online and real-time searching of videos of interest to users. The model can be updated regularly offline through the training process shown in FIG. 23. The training process includes the following operations: Operation S231: Construct a training sample. Operation S232: Update a model parameter. Operation S233: Explore a multi-target weight.

In operation S231, the training sample is used for offline training of the model. The construction process is divided into two operations: selecting positive and negative samples and associating features.

During the selecting of the positive and negative samples, the positive and negative samples are represented as: [user ID, video ID, clicked/tapped or not, playback duration, request ID], including five fields. For example, in a training sample of a fine sorting model, “actual exposure and playback behavior data” is used as the positive samples, and the positive sample may be represented as: [user ID, video ID, 1, playback duration, request ID]; “actual exposure without playback behavior data” is used as the negative samples, and the negative sample may be represented as: [user ID, video ID, 0, 0, request ID]. A positive sample selecting method may be reused in the video recall model, but a negative sample selecting method is not applicable. Therefore, optimization is performed in this embodiment of the present disclosure, as shown in FIG. 24, including increasing a quantity of random negative samples and reducing a quantity of true negative samples.

During increasing of the random negative samples, when searching for videos of interest to users online in real time, a video candidate set 241 dealt with by the recall model is a resource pool of millions of videos. Therefore, different from sample fine sorting that only use actual behavior data as the method for selecting positive and negative samples, recalling samples need to add randomly sampled negative samples (that is, random negative samples 242). Because the candidate set dealt with by the fine sorting model includes videos that is relatively matched with interests of the uses and that are obtained after recall and coarse sorting and selecting, a main purpose is to determine, from the set, parts which the user is more interested in. However, the video recall model also needs to have an ability to identify videos that the user is completely uninterested in from the entire candidate set, in other words, to separate, to the greatest extent, the videos that the user is interested in from the videos that the user is uninterested in.

A candidate set of the random negative samples 242 is the entire video candidate set 241. For each positive sample, the user ID and the request ID are extracted, and n video IDs are randomly selected to be concatenated to form negative samples. The negative sample is represented as: [user ID, video ID, 0, 0, request ID]. There are n negative samples in total, and n may be determined through offline test. In this embodiment of the present disclosure, random negative samples are introduced to simulate videos that the user is completely uninterested in, so that the video recall model can process more parts to be filtered out at a training stage, thereby strengthening interest discrimination determining of the candidate set.

During reducing the true negative samples 244, the introduction of the random negative samples significantly increases a quantity of samples, and consequently, training time is prolonged, and more computing and storage resources are required, resulting in an impact on an update speed of the model and insufficient learning of user behavioral features. Therefore, this method needs to be further optimized. To reduce the quantity of samples, the method used in this embodiment of the present disclosure is to randomly sample true negative samples. The true negative samples are exposure without playback behavior data of the user. As transitional data between videos that the user is interested in and videos that the user is uninterested in, if there are excessive true negative samples in the training sample, the model is misled to excessively tend to learn this part of fuzzy behavior, and consequently an ability of the model to achieve a more important goal, that is, to isolate videos of interest from videos of no interest to the greatest extent, is interfered. After offline test, in this embodiment of the present disclosure, a ratio of the true positive samples 243 to the true negative samples 244 to the random negative samples 242 may be 1:1:4, that is, true positive samples to true negative samples to random negative samples is equal to 1:1:4. In other words, the quantity of random true negative samples 245 obtained through random sampling is the same as the quantity of true positive samples. For each positive sample, four videos are randomly selected as random negative samples.

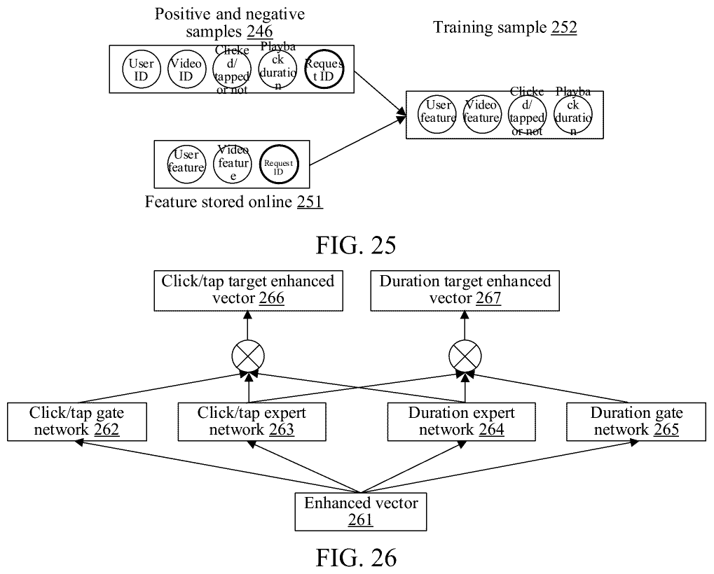

During associating of the features, an object feature may be associated through a user ID and a video feature may be associated through a video ID based on selected positive and negative samples 246, as shown in FIG. 25. Feature values corresponding to some features such as a playback sequence of the user and the city where the user is located are changing, and feature values corresponding to some features such as video views and click/tap rates are also changing. If the same user has different access time, corresponding request time is different, and these features are different. Therefore, object features and video features are generally stored in the recommendation service with the request ID when the user accesses. In this case, the training sample may be expressed as: [object feature, video feature, request ID]. In addition, during offline, the request IDs of the positive and negative samples are associated with request IDs of online stored features 251, to match the object features and video features when the request occurs, for obtaining a final training sample 252. The training sample may be represented as: [object feature, video feature, clicked/tapped or not, playback duration]. During offline training, “object feature” is inputted into the user tower, “video feature” is inputted into the video tower, “clicked/tapped or not” is the click/tap target, and “playback duration” is the duration target.

In operation S232, the process of updating the model is the process of updating its own parameters. After the constructed sample is inputted into the model, a corresponding loss needs to be calculated, and the model adjusts its own parameters by reducing the loss. The loss of the model may be calculated by inputting the target value and the predicted value into the loss function. The loss of the model is used for measuring a difference between the target value and the predicted value. A smaller loss indicates a smaller difference. The model continuously fits targets by continuously reducing the loss at the training stage. In this embodiment of the present disclosure, in addition to fitting the click/tap target and the duration target using the predicted value, the enhanced vector of the current tower also needs to be used to fit the two target vectors outputted by another tower. Each fitting process requires its own loss function. To adaptively fuse a plurality of losses together during the training, the fusion method in which a fixed loss weight is used is also optimized in this embodiment of the present disclosure to implement that each predicted value is balanced and close to the target value. Several loss calculations in embodiments of the present disclosure are described below.

### (1) Click/Tap Target Loss

A click/tap target has two types based on “click/tap or not”. Because the target is a discrete value and falls within binary prediction, a logarithmic loss function as shown in the following formula (1) is used in embodiments of the present disclosure. A process of calculating a loss is as follows. First, a target value, that is, y, is determined. The target value is 0 if a video is exposed but not played, and the target value is 1 if the video is exposed and played. Then, a predicted value, that is, σ( [symbol] pᵤ,pᵥ [symbol] ), is calculated. An inner product of a user click/tap target vector pᵤ and a video click/tap target vector pᵥ is first calculated and then outputted through a sigmoid activation function (σ) as the predicted value. Finally, a logarithmic loss is calculated, and the target value and the predicted value are inputted into the logarithmic loss function to obtain a logarithmic loss loss_{clk}. T represents a quantity of training samples.

$${loss}_{c l k} = - \frac{1}{T} \sum [ y log σ ( 〈 {p}_{u} , {p}_{v} 〉 ) + ( 1 - y ) log ( 1 - σ ( 〈 {p}_{u} , {p}_{v} 〉 ) ) ] . \qquad ( 1 )$$

### (2) Duration Target Loss

A duration target is actual playback duration of a user. The duration target is 0 if a video is not clicked/tapped, and the duration target is a decimal number greater than 0 if a video is clicked/tapped. Because the target is a continuous value and falls within regression prediction, a mean square error loss function as shown in the following formula (2) is used in embodiments of the present disclosure. A process of calculating a loss is as follows. First, a duration target min(dur,max_{dur}) is truncated. Because a user may forget to exit playing or an error exists in duration reporting, there is an abnormally great value in a duration target dur in a sample. To avoid interfering fitting the duration target by a recall model, truncation needs to be performed based on a specified truncated value. In embodiments of the present disclosure, equal-frequency of the duration target in testing samples randomly selected through offline statistics may be divided into 100 ranges, and a minimum value of the 100^{th} range is used as the specified truncated value max_{dur} (that is, the foregoing target truncated value). An original value is maintained if the duration target is less than or equal to the truncated value, and the original value is replaced with the truncated value if the duration target is greater than the truncated value. Then, the duration target is normalized to obtain a normalized duration truncated value

$$\frac{min ( dur , {max}_{dur} )}{{max}_{dur}} .$$

Because the duration target after the truncation has a wide span from zero second to tens of thousands seconds, parameter fluctuation is dramatic when the model learns different samples, and because a sharing parameter exists in a PLE network and even interferes learning a click/tap target, a span range needs to be adjusted. To not change distribution of the duration targets in the sample, normalization processing is performed on the duration truncated values by using a MinMax function in embodiments of the present disclosure. min in the function is 0, and max is a specified maximum truncated value max_{dur}. After the duration target is outputted through the MinMax function, the output of the MinMax function is used as a target value, and the span range corresponding to the duration target is adjusted to [0, 1.0]. In this way, the span range of the duration target is significantly narrowed, to facilitate model fitting. Next, a predicted value, that is, σ( [symbol] dᵤ,dᵥ [symbol] ), in a duration dimension is calculated. To fit the target value, the predicted value needs to be the same as the span range of the target value, for example, a span range of the predicted value is also [0, 1.0]. In embodiments of the present disclosure, an inner product of a user duration target vector dᵤ and a video duration target vector dᵥ is first calculated, then the inner product is inputted into a sigmoid activation function (σ) to obtain an output result, and the output result is used as a predicted value in a duration dimension. Finally, a mean square error is calculated. The target value and the predicted value may be inputted into a mean square error loss function (2) to obtain a mean square error loss loss_{dur}.

$${loss}_{d u r} = \frac{1}{T} \sum {[ \frac{min ( d ur , {max}_{dur} )}{{max}_{d u r}} - σ ( 〈 {d}_{u} , {d}_{v} 〉 ) ]}^{2} . \qquad ( 2 )$$

### (3) Enhanced Vector Loss and Target Vector Loss

To resolve a problem that an enhanced vector of an original double-enhanced dual-tower structure cannot fit a plurality of target vectors at the same time, in this embodiments of the present disclosure, an MMOE network is added in a fitting process, as shown in FIG. 26. The MMOE network is a primary multi-target network, and the MMOE network may output a plurality of vectors corresponding to a plurality of targets. Compared with a PLE network, the MMOE network includes only an expert network and a gate network without a sharing network. When few layers are configured, there is also a small parameter scale, without leading to over learning of this part of the structure by the model. When inputted samples are positive samples, an enhanced vector 261 passes through a click/tap gate network 262, a click/tap expert network 263, a duration expert network 264, and a duration gate network 265 in the MMOE network, and a click/tap target enhanced vector 266 and a duration target enhanced vector 267 are outputted. The model respectively calculates a mean square error loss loss_{aug} (with reference to the following formula (3), where tᵢ represents each bit of the target vector, and aᵢ represents each bit of the target vector) between a target enhanced vector of a current tower and a target enhanced vector of another tower in each target dimension, to obtain four losses in total, which is a user enhanced loss of a click/tap target, a video enhanced loss of the click/tap target, a user enhanced loss of a duration target, and a video enhanced loss of the duration target.

$${loss}_{aug} = \frac{1}{T} \sum \sum {( {t}_{i} - {a}_{i} )}^{2} . \qquad ( 3 )$$

Because the enhanced vector is an input of the current tower, and the fitted target vector is an output of the another tower, during calculation, the target vector needs the enhanced vector inputted by the another tower. Due to dependence between the target vector and the enhanced vector, the target vector needs to be fixed if the model updates the enhanced vector, otherwise, a model parameter cannot be updated.

### (4) Fused Loss

During training, when a model deals with a plurality of target losses, weighted summation is generally performed on the losses, and a weighted summation result is used as a fused loss. After the fused loss is calculated, the loss can be reduced through reducing the fused loss. A weight of each loss may be determined through an offline test. However, during training, when different training samples are inputted, due to a difference between data, a plurality of targets of the fixed weights are inevitably not balanced. In this case, an uncertainty weighting method is used in embodiments of the present disclosure, and the weight of each loss is adaptively adjusted to achieve a balanced close to a target value for each predicted value.

In embodiments of the present disclosure, the targets dealt with by the model include a total of six losses: a click/tap target loss, a duration target loss, a user enhanced loss of a click/tap target, a video enhanced loss of the click/tap target, a user enhanced loss of a duration target, and a video enhanced loss of the duration target. A corresponding original uncertainty weighting formula is the following formula (4). loss_{clk}, loss_{dur}, loss_{u_clk_aug}, loss_{u_dur_aug}, loss_{v_clk_aug}, and loss_{v_dur_aug} correspond to the six target losses respectively. w_{clk}, w_{dur}, w_{u_clk_aug}, w_{u_dur_aug}, w_{v_clk_aug}, and w_{v_dur_aug} are weights of the six target losses respectively. log(w_{clk}w_{dur}w_{u_clk_aug}w_{u_dur_aug}w_{v_clk_aug}w_{v_dur_aug}) is used as a regularization term to prevent the learned weight from being too large. Because the weight changes dynamically during the training, w_{clk}w_{dur}w_{u_clk_aug} w_{u_dur_aug}w_{v_clk_aug}w_{v_dur_aug} may be a negative number, resulting in incorrect calculation of a fused target loss thus training failure. Therefore, the regularization term is adjusted to formula (5) in embodiments of the present disclosure, to ensure that the fused target loss of training in each operation is calculated correctly.

$$loss = \frac{1}{2 {w}_{c l k}^{2}} {loss}_{c l k} + \frac{1}{2 {w}_{d u r}^{2}} {loss}_{d u r} + \frac{1}{2 {w}_{u \_ clk \_ aug}^{2}} {loss}_{u \_ clk \_ aug} + \frac{1}{2 {w}_{u \_ dur \_ aug}^{2}} {loss}_{u \_ dur \_ aug} + \frac{1}{2 {w}_{v \_ clk \_ aug}^{2}} {loss}_{v \_ clk \_ aug} + \frac{1}{2 {w}_{v \_ dur \_ aug}^{2}} {loss}_{v \_ dur \_ aug} + log ( {w}_{c l k} {w}_{d u r} {w}_{u \_ clk \_ aug} {w}_{u \_ dur \_ aug} {w}_{v \_ clk \_ aug} {w}_{v \_ dur \_ aug} ) ; \qquad ( 4 )$$

$$norm = log ( {w}_{clk}^{2} {w}_{dur}^{2} {w}_{u \_ clk \_ aug}^{2} {w}_{v \_ clk \_ aug}^{2} {w}_{u \_ dur \_ aug}^{2} {w}_{v \_ dur \_ aug}^{2} ) . \qquad ( 5 )$$

When the model in embodiments of the present disclosure is updated periodically, continuous learning of the latest user behavior feature by incrementally inputting samples, calculating losses, and reducing losses can be implemented, to ensure that videos retrieved online are more in line with user interests.

In operation S233, because an online available model has been created and updated through the previous operations, after the features of the user and the video are inputted, the multi-target vectors of the user and the video is outputted. However, when similarity scores between the user and the video are calculated, a click/tap target weight and a duration target weight, for example, α and β in calculating the multi-target similarity in the foregoing calculation process, also need to be determined, and are determined through offline test in embodiments of the present disclosure.

First, a click/tap target weight is explored. The click/tap target falls within binary prediction. An AUC is used in embodiments of the present disclosure to determine α and β. When the AUC is calculated, a target value is 0 or 1, and predicted values are similarity scores between different α and β. A higher AUC indicates more suitable α and β. Then, a duration target weight is explored. The duration target falls within regression prediction. Average top duration of a single test set (AD@K) may be used to determine α and β. Refer to the following formula (6). First, test samples are selected, and similarity scores between different α and β are calculated. If the samples are randomly divided into n test sets (batches), each with m samples, then n*m is a total quantity of the test samples. Second, sorting is performed based on the similarity scores in descending order in each test set (batch). Summation is first performed on duration of the first k samples to obtain top duration, and then summation is performed on the top duration of all of the test sets (batches). A sum result is finally divided by n to obtain AD@K. A higher AD@K indicates more suitable α and β. durᵢⱼ represents a duration target corresponding to a j^{th} sample in an i^{th} test set.

$$AD @ K = \frac{{\sum }_{i = 1}^{n} {\sum }_{j = 1}^{k} d u {r}_{ij}}{n} . \qquad ( 6 )$$

Finally, a multi-target weight is explored. Because α and β corresponding to the highest AUC are generally different from α and β corresponding to the highest AD@K, it is necessary to determine the most appropriate α and β that satisfy both targets. In embodiments of the present disclosure, a plurality of explorations may be used to determine the final α and β. First, value ranges of α and β in the first round of test are defined. In embodiments of the present disclosure, the value ranges are [1, 10], and a step is 1. Because there are two weights, exploration is performed 100 times. For each group of α and β, corresponding <AUC, AD@K> is calculated. However, order of magnitude of AUC and AD@K is different, and it is not convenient for directly comparing AUC and AD@K. In embodiments of the present disclosure, a MinMax function is first used for normalization, and then a difference minus between α and β in each group is compared, as shown in the following formula (7). The closer the difference minus is to 0, the more appropriate α and β are. Finally, α₁ and β₁ with the smallest difference in the first round are determined, and in subsequent exploration, α is fixed to α₁, and only a more accurate β is explored. Second, a value range of β in the second round of test is defined. In embodiments of the present disclosure, the value range of β is (β₁−1, β₁+1), a step is 0.1, and exploration is performed 19 times. Finally, β₂ with the smallest difference in the second round is determined. Third, a value range of β in the third round of test is defined. In embodiments of the present disclosure, the value range of β is (β₂−0.1, β₂+0.1), a step is 0.01, and exploration is performed 19 times. Finally, β₃ with the smallest difference in the second round is determined. Fourth, a loop is performed from the first operation to the third operation. In embodiments of the present disclosure, exploration is performed on y for five rounds, and the finally obtained α₁ and β₅ are target weights under click/tap and duration respectively, which are used to calculate online a similarity score between a user and a video. In formula (7), min_{AUC} represents a minimum AUC value in this round of test. max_{AUC} represents a maximum AUC value in this round of test. min_{AD@K} represents a minimum AD@K value in this round of test. max_{AD@K} represents a maximum AD@K value in this round of test.

$$minus = \frac{A U C - {min}_{A U C}}{{max}_{A U C} - {min}_{A U C}} - \frac{A D @ K - {min}_{A D @ K}}{{max}_{A D @ K} - {min}_{A D @ K}} . \qquad ( 7 )$$

The application process of the video recommendation method according to this embodiment of the present disclosure is described below.

In this embodiment of the present disclosure, after a video recall model is updated each time, features of a video candidate set are first inputted into a video tower in batches to generate a video click/tap target vector and a video duration target vector of a corresponding video, and then each bit of the two target vectors is multiplied by their respective weights and concatenated together to obtain a concatenated vector. The concatenated vector is used as a video multi-target vector. Finally, an index for online real-time query is created for the video multi-target vector, so that the video multi-target vector can be directly queried based on the index, to ensure that there is no need to repeatedly generate the video multi-target vector online. After an index of each video multi-target vector is created, the model is deployed online to ensure that a user multi-target vector that is generated in real time is consistent with a model version corresponding to a video multi-target vector. When a user slides down and browses or refreshes a non-target region in each channel of a video application, a feature of the user making a request is inputted into a user tower online and in real time. A corresponding user click/tap target vector and a corresponding user duration target vector are generated by using the user tower. Then, the user click/tap target vector and the user duration target vector are concatenated into a user multi-target vector. Finally, a nearest neighbor algorithm is used to query a top video with the highest similarity score and return the video. During implementation, the queried videos and other recalled videos may be combined and deduplicated sequentially, and then logical processing such as fine sorting and mixed sorting continue to be performed. Finally, selected target recommended videos are recommended to the user in a form of material cards in the non-target region.

In embodiments of the present disclosure, a user enhanced vector is initialized using a playback sequence. In this way, while ensuring differentiation of different users, computing and storage resources can be significantly saved by reducing the scale of model parameters, and expression accuracy of the enhanced vectors can be improved by increasing training opportunities of each video ID in the playback sequence. In addition, PLE network is adopted in each tower in embodiments of the present disclosure, to output a plurality of vectors after inputting features. The plurality of vectors are used to fit a plurality of targets such as clicks/taps and duration, and the plurality of vectors may be adjusted based on service targets. In embodiments of the present disclosure, when an enhanced vector inputted by a current tower fits a target vector outputted by another tower, an MMOE network is added to implement that a plurality of target vectors are fitted at the same time using one enhanced vector. In addition, in embodiments of the present disclosure, a method for calculating a target value and a predicted value in a duration target loss function is also redesigned to obtain a duration target loss. In this way, after the duration target loss is added to other losses such as a click/tap target loss and an enhanced target loss, a plurality of losses are fused based on an improved version of uncertainty weighting to implement that each predicted value is balanced and close to the target value. In addition, in embodiments of the present disclosure, when a multi-target similarity score between a user and a video is calculated in real time, a multi-target weight used can be determined by the exploration method designed in embodiments of the present disclosure, so that the most appropriate weights that satisfy the plurality of targets simultaneously can be obtained offline.

In embodiments of the present disclosure, the user enhanced vector is initialized by using the playback sequence. Because the playback sequence includes a playback order in addition to a video ID and playback duration, a sequence model can be used to introduce sequential information into the user enhanced vector, for example, a model such as a long short-term memory (LSTM) network, a transformer model, and a BERT model. In embodiments of the present disclosure, for a multi-target network of each tower, another structure such as a ResNet structure or a parallel dual-tower structure can be used to replace a PLE network, to enhance an expression ability of the multi-target vector. In addition to being used for recall of material cards in a target region of any video application, the video recall model in embodiments of the present disclosure may further be used to personalize an optimization target of the model based on characteristics of scenarios of different video applications.

In embodiments of the present disclosure, if content related user information, such as object feature vectors, historical playback sequences, and target recommended videos, includes data related to user information or enterprise information, when embodiments of the present disclosure are applied to specific products or technologies, user permission or consent is required, collection and processing of related data need to strictly comply with relevant laws and regulations of relevant countries during actual application, informed consent or separate consent of the personal information subject needs to be obtained, and subsequent data is used and processed within the scope of authorization of laws and regulations and the personal information subject.

The following still describes an exemplary structure in which the video recommendation apparatus 354 provided in this embodiment of the present disclosure is implemented as the software module. In some embodiments, as shown in FIG. 4, the video recommendation apparatus 354 includes: the obtaining module 3541, configured to obtain an object feature vector of a target object, a historical playback sequence of the target object in a preset historical time period, and a video multi-target vector index of each video in a video library; the vectorization processing module 3542, configured to perform vectorization processing on the historical playback sequence to obtain an object enhanced vector of the target object; the multi-target processing module 3543, configured to sequentially perform vector concatenation processing and multi-target feature learning on the object feature vector and the object enhanced vector to obtain an object multi-target vector of the target object; the determining module 3544, configured to determine, from the video library based on the object multi-target vector and the video multi-target vector index of each video, a target recommended video corresponding to the target object; and the video recommendation module 3545, configured to perform video recommendation to the target object based on the target recommended video.

In some embodiments, the apparatus further includes: a retrieval module, configured to search a preset feature vector list based on a video identifier of each video to obtain a video enhanced vector of each video correspondingly; a vector concatenation module, configured to perform vector concatenation processing on a video feature vector and the video enhanced vector of each video to obtain a video concatenated vector of each video correspondingly; a multi-target feature learning module, configured to perform multi-target feature learning on the video concatenated vector of each video to obtain a video multi-target vector of each video correspondingly; and a creating module, configured to create the video multi-target vector index corresponding to the video multi-target vector of each video.

In some embodiments, the vectorization processing module is further configured to: obtain a historical video identifier and historical playback duration of each historically played video in the historical playback sequence; search a preset feature vector list based on each historical video identifier to obtain a historical video vector set, a quantity of historical video vectors in the historical video vector set is the same as a quantity of the historical video identifiers in the historical playback sequence; calculate the total of the historical playback duration in the historical playback sequence to obtain total historical playback duration; perform duration normalization processing on each historical playback duration based on the total historical playback duration to obtain normalized playback duration of each historically played video, and determine the normalized playback duration as a video vector weight of the corresponding historically played video; perform weighting processing on each historical video vector in the historical video vector set based on the video vector weight to obtain a video weighted vector set; and perform combination processing on video weighted vectors in the video weighted vector set to obtain the object enhanced vector of the target object.

In some embodiments, the multi-target processing module is further configured to: perform the vector concatenation processing on the object feature vector and the object enhanced vector to obtain an object concatenated vector; perform the multi-target feature learning on the object concatenated vector by using a multi-target neural network to obtain object target vectors of the target object in a plurality of target dimensions; and perform concatenation processing on the object target vectors in the plurality of target dimensions to obtain the object multi-target vector of the target object.

In some embodiments, the multi-target feature learning module is further configured to: perform, for each video, the multi-target feature learning on the video concatenated vector of the video by using a multi-target neural network to obtain video target vectors of the video in a plurality of target dimensions; obtain a target weight in each target dimension; perform weighting calculation on the video target vector in each target dimension by using the target weight to obtain a weighted video target vector; and perform concatenation processing on the weighted video target vectors in the plurality of target dimensions to obtain the video multi-target vector of the video.

In some embodiments, the determining module is further configured to: obtain a video multi-target vector of each video based on the video multi-target vector index; determine an inner product of the object multi-target vector and the video multi-target vector of each video, and determine the inner product as a similarity score between the target object and the corresponding video; select a specific quantity of videos from the video library based on the similarity scores; and determine the specific quantity of selected videos as target recommended videos corresponding to the target object.

In some embodiments, the video recommendation method is implemented by using a video recall model. The video recommendation apparatus further includes a model training apparatus. The model training apparatus is configured to: obtain sample data, the sample data including: a sample object feature, a sample video feature, and target parameters in the plurality of target dimensions; input the sample object feature into an object tower of the video recall model, and predict sample object target vectors of a sample object in the plurality of target dimensions based on the sample object feature by using the object tower; input the sample video feature into a video tower of the video recall model, and predict sample video target vectors of a sample video in the plurality of target dimensions based on the sample video feature by using the video tower; input the sample object target vector, the sample video target vector, and the target parameter into a target loss model, and perform loss calculation by using the target loss model to obtain a target loss result; and correct parameters in the object tower and the video tower based on the target loss result to obtain a trained video recall model.

In some embodiments, the model training apparatus is further configured to: obtain original sample data, the original sample data including a plurality of true positive samples and a plurality of true negative samples; construct random negative samples based on the plurality of true positive samples, and removing a part of true negative samples from the plurality of true negative samples, a quantity of the true positive samples, a quantity of the true negative samples remained after the part of true negative samples are removed, and a quantity of the random negative samples exhibiting a preset proportional relationship; determine the true positive samples as positive samples, and determine the true negative samples remained after the part of true negative samples are removed and the random negative samples as negative samples; and perform feature association on the positive samples and the negative samples based on an object identifier and the video identifiers to obtain the sample data.

In some embodiments, the sample object target vector includes an object click/tap target vector; the sample video target vector includes a video click/tap target vector; and the target parameter includes a click/tap target value. The model training apparatus is further configured to: determine a vector inner product of the object click/tap target vector and the video click/tap target vector based on the target loss model; determine a predicted value in a click/tap dimension based on the vector inner product and a preset activation function; determine a logarithmic loss between the predicted value in the click/tap dimension and the click/tap target value by using a logarithmic loss function; and determine the logarithmic loss as the target loss result.

In some embodiments, the sample object target vector includes an object duration target vector; the sample video target vector includes a video duration target vector; and the target parameter includes a duration target value. The model training apparatus is further configured to: perform truncation processing on the duration target value based on a preset truncation range quantity to obtain a truncation range quantity of duration truncated values; determine a target truncated value based on the truncation range quantity of duration truncated values; perform normalization processing on each duration truncated value based on the target truncated value to obtain a normalized duration truncated value; determine a vector inner product of the object duration target vector and the video duration target vector; determine a predicted value in a duration dimension based on the vector inner product and a preset activation function; determine a mean square error loss between the predicted value in the duration dimension and the normalized duration truncated value by using a mean square error loss function; and determine the mean square error loss as the target loss result.

In some embodiments, the video recall model further includes a multi-target network. The model training apparatus is further configured to: output target enhanced vectors corresponding to the object tower and the video tower in the plurality of target dimensions through the multi-target network when the sample data is positive samples; determine, in each target dimension, a first mean square error between the target enhanced vector corresponding to the object tower and the sample video target vector outputted by the video tower, or a second mean square error between the target enhanced vector corresponding to the video tower and the sample object target vector outputted by the object tower; and determine the first mean square error and the second mean square error as an object enhanced loss of the sample object and a video enhanced loss of the sample video, respectively, the object enhanced loss and the video enhanced loss being parts of the target loss result.

In some embodiments, the target loss result includes a logarithmic loss in a click/tap dimension, a mean square error loss in a duration dimension, an object enhanced loss in the click/tap dimension, a video enhanced loss in the click/tap dimension, an object enhanced loss in the duration dimension, and a video enhanced loss in the duration dimension. The model training apparatus is further configured to: obtain loss weights respectively corresponding to the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension; obtain a preset regularization term; perform loss fusion processing on the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension based on the loss weights and the regularization term to obtain a fused loss result; and correct the parameters in the object tower and the video tower based on the fused loss result to obtain the trained video recall model.

In some embodiments, the model training apparatus is further configured to: input the sample object target vector and the sample video target vector into a recommendation prediction layer of the video recall model, and determine, based on the recommendation prediction layer, a click/tap parameter and a video duration parameter of the sample object in respect of the sample video; determine a performance indicator value of the video recall model based on the click/tap parameter; determine average top duration of the video recall model based on the video duration parameter; and perform a plurality of cyclic tests based on the performance indicator value and the average top duration to obtain a target weight in the click/tap dimension and a target weight in the duration dimension.

The descriptions of the apparatus in this embodiment of the present disclosure are similar to the foregoing descriptions of the method embodiment, and the has beneficial effects similar to those of the method embodiments. Therefore, details are not described herein again. For technical details not disclosed in this apparatus embodiment, refer to descriptions in the method embodiment of the present disclosure for understanding.

An embodiment of the present disclosure provides a computer program product or a computer program. The computer program product or the computer program includes executable instructions stored on a computer-readable storage medium. When a processor of an electronic device reads the executable instructions from the computer-readable storage medium and executes the executable instructions, the processor enables the electronic device to perform the foregoing video recommendation method in embodiments of the present disclosure.

An embodiment of the present disclosure provides a storage medium having executable instructions stored thereon. When the executable instructions are executed by a processor, the processor is enabled to implement the video recommendation method provided in embodiments of the present disclosure, for example, the video recommendation method shown in FIG. 5. In some embodiments, the storage medium may be a computer-readable storage medium, for example, a memory such as a ferromagnetic random access memory (FRAM), a read only memory (ROM), a programmable read only memory (PROM), an erasable programmable read only memory (EPROM), an electrically erasable programmable read only memory (EEPROM), a flash memory, a magnetic storage, an optic disc, or a compact disc read only memory (CD-ROM), and may alternatively be various devices including one of the foregoing memories or any combination thereof.

Embodiments of the present disclosure provide technical beneficial effects. As disclosed, vectorization processing is performed on a historical playback sequence of a target object to obtain an object enhanced vector of the target object for determining an object multi-target vector of the target object based on the object enhanced vector of the target object. The object multi-target vector is an object feature vector fusing the object enhanced vector. In this manner, in determining a target recommended video from a video library based on the object multi-target vector and a video multi-target vector index of each video, the target object can be accurately analyzed with reference to information of the target object in multiple dimensions, so that video recall can be accurately performed. In addition, the object enhanced vector is generated based on the historical playback sequence of the target object, the historical playback sequence includes a playback record of videos played by the target object, and a quantity of playback records is significantly less than a quantity of target objects that use a video application. Therefore, for determining the object multi-target vector of the target object based on the object enhanced vector and determining the target recommended video, small amount of data calculation is needed, and efficiency of video recommendation can be greatly improved.

In some embodiments, the executable instructions may be written in the form of program, software, software module, script, or code in any form of programming language (including compilation or interpretation language, or declarative or procedural language), and the executable instructions may be deployed in any form, including being deployed as an independent program or being deployed as a module, component, subroutine, or other units suitable for use in a computing environment.

As an example, the executable instructions may, but not necessarily, correspond to a file in a file system, and may be stored in a part of a file that stores other programs or data, for example, stored in one or more scripts in a hypertext markup language (HTML) document, stored in a single file dedicated to the program under discussion, or stored in a plurality of collaborative files (for example, a file that stores one or more modules, subroutines, or code parts). As an example, the executable instructions may be deployed to be executed on a single electronic device, or on a plurality of electronic devices located in a single location, or on a plurality of electronic devices distributed in a plurality of locations and interconnected through a communication network.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing descriptions are merely embodiments of the present disclosure and are not intended to limit the protection scope of the present disclosure. Any modification, equivalent replacement, and improvement made within the spirit and scope of the present disclosure fall within the protection scope of the present disclosure.

What is claimed is:

1. A video recommendation method, performed by an electronic device, the method comprising:
obtaining an object feature vector of a target object, a historical playback sequence of the target object in a preset historical time period, and a video multi-target vector index of each video in a video library;
obtaining an object enhanced vector of the target object by performing vectorization processing on the historical playback sequence;
obtaining an object multi-target vector of the target object by sequentially performing vector concatenation processing and multi-target feature learning on the object feature vector and the object enhanced vector;
determining, from the video library based on the object multi-target vector and the video multi-target vector index of each video, a target recommended video corresponding to the target object; and
performing video recommendation to the target object based on the target recommended video.

2. The method according to claim 1, further comprising:
searching a preset feature vector list based on a video identifier of each video to obtain a video enhanced vector of each video correspondingly;
performing vector concatenation processing on a video feature vector and the video enhanced vector of each video to obtain a video concatenated vector of each video correspondingly;
performing multi-target feature learning on the video concatenated vector of each video to obtain a video multi-target vector of each video correspondingly; and
creating the video multi-target vector index corresponding to the video multi-target vector of each video.

3. The method according to claim 2, wherein performing the multi-target feature learning on the video concatenated vector of each video comprises:
performing, for each video, the multi-target feature learning on the video concatenated vector of the video by using a multi-target neural network to obtain video target vectors of the video in a plurality of target dimensions;
obtaining a target weight in each target dimension;
performing weighting calculation on the video target vector in each target dimension by using the target weight to obtain a weighted video target vector; and
performing concatenation processing on the weighted video target vectors in the plurality of target dimensions to obtain the video multi-target vector of the video.

4. The method according to claim 1, wherein obtaining the object enhanced vector of the target object comprises:
obtaining a historical video identifier and historical playback duration of each historically played video in the historical playback sequence;
searching a preset feature vector list based on each historical video identifier to obtain a historical video vector set, a quantity of historical video vectors in the historical video vector set being the same as a quantity of the historical video identifiers in the historical playback sequence;
calculating the total of the historical playback duration in the historical playback sequence to obtain total historical playback duration;
performing duration normalization processing on each historical playback duration based on the total historical playback duration to obtain normalized playback duration of each historically played video, and determining the normalized playback duration as a video vector weight of the corresponding historically played video;
performing weighting processing on each historical video vector in the historical video vector set based on the video vector weight to obtain a video weighted vector set; and
performing combination processing on video weighted vectors in the video weighted vector set to obtain the object enhanced vector of the target object.

5. The method according to claim 1, wherein obtaining the object multi-target vector of the target object comprises:
performing the vector concatenation processing on the object feature vector and the object enhanced vector to obtain an object concatenated vector;
performing the multi-target feature learning on the object concatenated vector by using a multi-target neural network to obtain object target vectors of the target object in a plurality of target dimensions; and
performing concatenation processing on the object target vectors in the plurality of target dimensions to obtain the object multi-target vector of the target object.

6. The method according to claim 1, wherein determining the target recommended video corresponding to the target object comprises:
obtaining a video multi-target vector of each video based on the video multi-target vector index;
determining an inner product of the object multi-target vector and the video multi-target vector of each video, and determining the inner product as a similarity score between the target object and the corresponding video;
selecting a specific quantity of videos from the video library based on the similarity scores; and
determining the specific quantity of selected videos as target recommended videos corresponding to the target object.

7. The method according to claim 1, further comprising:
using a video recall model for the video recommendation method and training the video recall model by performing:
obtaining sample data, the sample data comprising: a sample object feature, a sample video feature, and target parameters in the plurality of target dimensions;
inputting the sample object feature into an object tower of the video recall model, and predicting sample object target vectors of a sample object in the plurality of target dimensions based on the sample object feature by using the object tower;
inputting the sample video feature into a video tower of the video recall model, and predicting sample video target vectors of a sample video in the plurality of target dimensions based on the sample video feature by using the video tower;
inputting the sample object target vector, the sample video target vector, and the target parameter into a target loss model, and performing loss calculation by using the target loss model to obtain a target loss result; and
correcting parameters in the object tower and the video tower based on the target loss result to obtain a trained video recall model.

8. The method according to claim 7, wherein obtaining the sample data comprises:
obtaining original sample data, the original sample data comprising a plurality of true positive samples and a plurality of true negative samples;
constructing random negative samples based on the plurality of true positive samples, and removing a part of true negative samples from the plurality of true negative samples, a quantity of the true positive samples, a quantity of the true negative samples remained after the part of true negative samples are removed, and a quantity of the random negative samples exhibiting a preset proportional relationship;
determining the true positive samples as positive samples, and determining the true negative samples remained after the part of true negative samples are removed and the random negative samples as negative samples; and
performing feature association on the positive samples and the negative samples based on an object identifier and the video identifiers to obtain the sample data.

9. The method according to claim 7, wherein the sample object target vector comprises an object click/tap target vector; the sample video target vector comprises a video click/tap target vector; and the target parameter comprises a click/tap target value; and
inputting the sample object target vector, the sample video target vector, and the target parameter into the target loss model, and performing the loss calculation by using the target loss model to obtain the target loss result comprises:
determining a vector inner product of the object click/tap target vector and the video click/tap target vector based on the target loss model;
determining a predicted value in a click/tap dimension based on the vector inner product and a preset activation function;
determining a logarithmic loss between the predicted value in the click/tap dimension and the click/tap target value by using a logarithmic loss function; and
determining the logarithmic loss as the target loss result.

10. The method according to claim 7, wherein the sample object target vector comprises an object duration target vector; the sample video target vector comprises a video duration target vector; and the target parameter comprises a duration target value; and
inputting the sample object target vector, the sample video target vector, and the target parameter into a target loss model, and performing the loss calculation by using the target loss model to obtain the target loss result comprises:
performing truncation processing on the duration target value based on a preset truncation range quantity to obtain a truncation range quantity of duration truncated values;
determining a target truncated value based on the truncation range quantity of duration truncated values;
performing normalization processing on each duration truncated value based on the target truncated value to obtain a normalized duration truncated value;
determining a vector inner product of the object duration target vector and the video duration target vector;
determining a predicted value in a duration dimension based on the vector inner product and a preset activation function;
determining a mean square error loss between the predicted value in the duration dimension and the normalized duration truncated value by using a mean square error loss function; and
determining the mean square error loss as the target loss result.

11. The method according to claim 7, wherein the video recall model further comprises a multi-target network; and the method further comprises:
outputting target enhanced vectors in the plurality of target dimensions through the multi-target network when the sample data is positive samples, the target enhanced vectors in the plurality of target dimensions comprising a target enhanced vector corresponding to the object tower and a target enhanced vector corresponding to the video tower;
determining, in each target dimension, a first mean square error between the target enhanced vector corresponding to the object tower and the sample video target vector outputted by the video tower, or a second mean square error between the target enhanced vector corresponding to the video tower and the sample object target vector outputted by the object tower; and
determining the first mean square error and the second mean square error as an object enhanced loss of the sample object and a video enhanced loss of the sample video, respectively, the object enhanced loss and the video enhanced loss being parts of the target loss result.

12. The method according to claim 7, wherein the target loss result comprises a logarithmic loss in a click/tap dimension, a mean square error loss in a duration dimension, an object enhanced loss in the click/tap dimension, a video enhanced loss in the click/tap dimension, an object enhanced loss in the duration dimension, and a video enhanced loss in the duration dimension; and
the method further comprises:
obtaining loss weights respectively corresponding to the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension;
obtaining a preset regularization term;
performing loss fusion processing on the logarithmic loss in the click/tap dimension, the mean square error loss in the duration dimension, the object enhanced loss in the click/tap dimension, the video enhanced loss in the click/tap dimension, the object enhanced loss in the duration dimension, and the video enhanced loss in the duration dimension based on the loss weights and the regularization term to obtain a fused loss result; and
correcting the parameters in the object tower and the video tower based on the fused loss result to obtain the trained video recall model.

13. The method according to claim 7, further comprising:
inputting the sample object target vector and the sample video target vector into a recommendation prediction layer of the video recall model, and determining, based on the recommendation prediction layer, a click/tap parameter and a video duration parameter of the sample object in respect of the sample video;
determining a performance indicator value of the video recall model based on the click/tap parameter;
determining average top duration of the video recall model based on the video duration parameter; and
performing a plurality of cyclic tests based on the performance indicator value and the average top duration to obtain a target weight in the click/tap dimension and a target weight in the duration dimension.

14. An electronic device, comprising:
a memory, configured to store executable instructions; and one or more processors, configured to execute the executable instructions stored in the memory and configured to perform:
obtaining an object feature vector of a target object, a historical playback sequence of the target object in a preset historical time period, and a video multi-target vector index of each video in a video library;
obtaining an object enhanced vector of the target object by performing vectorization processing on the historical playback sequence;
obtaining an object multi-target vector of the target object by sequentially performing vector concatenation processing and multi-target feature learning on the object feature vector and the object enhanced vector;
determining, from the video library based on the object multi-target vector and the video multi-target vector index of each video, a target recommended video corresponding to the target object; and
performing video recommendation to the target object based on the target recommended video.

15. The device according to claim 14, wherein the one or more processors are further configured to perform:
searching a preset feature vector list based on a video identifier of each video to obtain a video enhanced vector of each video correspondingly;
performing vector concatenation processing on a video feature vector and the video enhanced vector of each video to obtain a video concatenated vector of each video correspondingly;
performing multi-target feature learning on the video concatenated vector of each video to obtain a video multi-target vector of each video correspondingly; and
creating the video multi-target vector index corresponding to the video multi-target vector of each video.

16. The device according to claim 15, wherein the one or more processors are further configured to perform:
performing, for each video, the multi-target feature learning on the video concatenated vector of the video by using a multi-target neural network to obtain video target vectors of the video in a plurality of target dimensions;
obtaining a target weight in each target dimension;
performing weighting calculation on the video target vector in each target dimension by using the target weight to obtain a weighted video target vector; and
performing concatenation processing on the weighted video target vectors in the plurality of target dimensions to obtain the video multi-target vector of the video.

17. The device according to claim 14, wherein the one or more processors are further configured to perform:
obtaining a historical video identifier and historical playback duration of each historically played video in the historical playback sequence;
searching a preset feature vector list based on each historical video identifier to obtain a historical video vector set, a quantity of historical video vectors in the historical video vector set being the same as a quantity of the historical video identifiers in the historical playback sequence;
calculating the total of the historical playback duration in the historical playback sequence to obtain total historical playback duration;
performing duration normalization processing on each historical playback duration based on the total historical playback duration to obtain normalized playback duration of each historically played video, and determining the normalized playback duration as a video vector weight of the corresponding historically played video;
performing weighting processing on each historical video vector in the historical video vector set based on the video vector weight to obtain a video weighted vector set; and
performing combination processing on video weighted vectors in the video weighted vector set to obtain the object enhanced vector of the target object.

18. The device according to claim 14, wherein the one or more processors are further configured to perform:
performing the vector concatenation processing on the object feature vector and the object enhanced vector to obtain an object concatenated vector;
performing the multi-target feature learning on the object concatenated vector by using a multi-target neural network to obtain object target vectors of the target object in a plurality of target dimensions; and
performing concatenation processing on the object target vectors in the plurality of target dimensions to obtain the object multi-target vector of the target object.

19. The device according to claim 14, wherein the one or more processors are further configured to perform:
obtaining a video multi-target vector of each video based on the video multi-target vector index;
determining an inner product of the object multi-target vector and the video multi-target vector of each video, and determining the inner product as a similarity score between the target object and the corresponding video;
selecting a specific quantity of videos from the video library based on the similarity scores; and
determining the specific quantity of selected videos as target recommended videos corresponding to the target object.

20. A non-transitory computer-readable storage medium containing executable instructions that, when being executed, cause at least one processor to perform:
obtaining an object feature vector of a target object, a historical playback sequence of the target object in a preset historical time period, and a video multi-target vector index of each video in a video library;
obtaining an object enhanced vector of the target object by performing vectorization processing on the historical playback sequence;
obtaining an object multi-target vector of the target object by sequentially performing vector concatenation processing and multi-target feature learning on the object feature vector and the object enhanced vector;
determining, from the video library based on the object multi-target vector and the video multi-target vector index of each video, a target recommended video corresponding to the target object; and
performing video recommendation to the target object based on the target recommended video.
